(19) United States
(12) Patent Application Publication
(10) Pub. No.: US 2009/0279406 A1
(43) Pub. Date: Nov. 12, 2009

(54) HOLOGRAM RECORDING AND REPRODUCING SYSTEM

(75) Inventor: Masakazu Ogasawara, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 12/065,327

(22) PCT Filed: Aug. 9, 2006
(86) PCT No.: PCT/JP2006/316065

§ 371 Date: May 22, 2008

(30) Foreign Application Priority Data
Aug. 30, 2005 (JP) 2005-248957

(51) Int. Cl. G11B 7/00

(52) U.S. Cl. 369/103; G9B/7

(57) ABSTRACT

A hologram recording and reproducing system for recording or reproducing information to or from a hologram record carrier that stores an optical interference pattern of a reference beam and a signal beam therein as a diffraction grating, includes: light producing means that generates a reference beam and a signal beam based on a coherent beam in which the coherent beam is modulated into the signal beam according to information to be recorded; interference means that allows one of the reference and signal beams to propagate axially on an optical axis as a central region light flux and allows the other of the reference and signal beams to propagate coaxially and annularly in section as an annular region light flux surrounding the one spatially separated from the other in a same direction and converges both the reference beam and the signal beam on different focal points in the optical axis respectively through an objective lens optical system to cause interference between the reference beam and the signal beam; a hologram record carrier having a hologram record layer located on a side of a near one of the different focal points to the objective lens optical system and a reflection layer located on a side of a distant one of the different focal points from the objective lens optical system; and image detecting means arranged on the optical axis and for receiving a beam returning from the hologram record layer through the objective lens optical system when the reference beam is illuminated to the hologram record layer; wherein the hologram record carrier further comprising a servo guide layer which is placed at a position either nearer to the objective lens optical system than the hologram record layer or farther than the reflection layer from the objective lens optical system. The hologram recording and reproducing system further includes a servo control system for focusing a servo beam onto the servo guide layer and for receiving a reflection light returning from the servo guide layer to photoelectrically convert it to a signal and for driving the objective lens optical system in accordance with the signal photoelectrically converted, wherein the servo beam has a wavelength different from the coherent beam wavelength and passes through the central region coaxially with the central region light flux including the optical axis.

### TECHNICAL FIELD

The present invention relates to a record carrier, such as an optical disk, an optical card, that information is to be optically recorded and/or reproduced, and more particularly to an optical pickup apparatus and a hologram recording and reproducing system for a hologram record carrier having a hologram record layer that information can be recorded or reproduced by illuminating a light flux.

### BACKGROUND ART

Attentions are given to the hologram capable of recording two-dimensional data with density in order for dense recording of information. The feature of the hologram lies in that the wave front of light carrying record information is recorded as a volumetric change of refractive index in a recording medium formed of a photosensitive material, such as a photo-refractive material. Multiple recording on a hologram record carrier can drastically increase record capacity. As a structure, there is known a recording medium that a substrate, an information recording layer and a reflection layer are formed in this order.

For example, there is conventionally a technique (see Japanese Translation of PCT Publication No. 2002-513981) that polarization hologram recording is carried out by focusing circularly-polarized object and reference beams different in rotating direction from each other on a recording medium through the same lens, in an information recording apparatus that coaxially illuminates object and reference beams, for writing, short in wavelength onto a thin-film recording layer and recording a hologram by causing an interference. In the polarization holography recording, object and reference beams, i.e., two plane waves having polarizations orthogonal to each other, are turned into clockwise and counterclockwise circularly polarized beams by use of a ¼-wavelength plate so that a polarization hologram is recorded one through the interference of those within the recording medium. During reproducing, reproducing is performed on a separate reproducing optical system by use of a reading reference beam longer in wavelength than that of recording. The reproducing optical system is provided with an especial ½-wavelength plate having a central opening, to obtain reproduced light from the polarization hologram by centrally illuminating a reference beam. The reproduced light transmits through a part of the ½-wavelength plate around the opening because of the breadth thereof resulting from the reference beam having a long wavelength and changes polarization direction, thus being separated by the polarizing beam splitter into a detection of transmitted reproduced light. Accordingly, in the art of Japanese Translation of PCT Publication No. 2002-513981, there is a need to switch over the writing and reading wavelength light sources and optical systems upon recording and reproducing. Because the reflection light does not return from the recording medium during recording, another optical system is needed for servo control to align the illuminated light with the recording medium. Meanwhile, in the art of Japanese Translation of PCT Publication No. 2002-513981, shift multiplex recording is impossible to perform because the reference beam is collimated light at the inside of the recording medium.

Furthermore, conventionally, information light is convergently illuminated having a minimal diameter at the boundary between the hologram record layer and the protection layer of the recording medium, and then reflected by a reflection layer. Simultaneously, recording reference beam is illuminated as divergent light by converging it at a minimal diameter in front of the boundary between the hologram record layer and the protection layer so that recording can be made in the hologram record layer by causing an interference (see Japanese Patent Laid-Open No. H11-311938).

Meanwhile, there is also an art that, in the recording optical system, information light is converged onto the reflection layer so that recording reference beam is defocused on the reflection layer wherein the recording reference beam is illuminated such that the conjugate focal point of the recording reference beam comes to a point closer to the substrate than the boundary of the substrate and the information record layer (see Japanese Patent Laid-Open No. 2004-171611).

### DISCLOSURE OF THE INVENTION

FIGS. 1 and 2 show objective-lens structural examples in the form that recording and reproducing is made at one side of the record layer in the prior art, e.g., in the art disclosed in Japanese Patent Laid-Open Nos. H11-311938 and 2004-171611.

In both of the arts, during recording, the reference and signal beams are guided to the objective lens in a manner coaxial to and overlapping with each other as shown in the figure. The reference and signal beams are established different in focal length after the passage through the objective lens OB.

In FIG. 1(a), the signal beam is focused on a point (focal point P) where the reflection layer is to be arranged whereas the reference beam is focused on a point (focal point P1) in front of the focal point P. In FIG. 2(a), the signal beam is focused on a point (focal point P) where the reflection layer is to be arranged whereas the reference beam is focused on a point (focal point P2) farther than the focal point P. In the both cases, the reference and signal beams collected by the objective lens OB are always in an interference state on the optical axis. Accordingly, as shown in FIGS. 1(b) and 2(b), where the reflection layer is arranged in the position of the focal point P as to the signal beam while the recording medium is arranged between the objective lens and the reflection layer, the reference and signal beams pass the recording medium in both ways thereby effecting hologram recording. During reproducing, the reference beam passes the recording medium in both ways so that the reflected reference beam returns together with the reproduced light to the objective lens OB.

As shown in FIG. 3, the hologram to be concretely recorded is in four types, i.e., hologram record A (a reflecting reference beam and a reflecting signal beam), hologram record B (an incident reference beam and a reflecting signal beam), hologram record C (a reflecting reference beam and an incident signal beam), hologram record D (an incident reference beam and an incident signal beam). Meanwhile, the hologram to be reproduced is in four types, i.e., hologram record A (to be read out by a reflecting reference beam), hologram record B (to be read out by an incident reference beam), hologram record C (to be read out by a reflecting reference beam), hologram record D (to be read out by an incident reference beam).

Accordingly, in the prior arts, because interference occurs in all the rays within the record layer (incident and reflected ones of light as to the reference beam and incident and reflected ones of light as to the information beam), a plurality of holograms are resultingly recorded or reproduced. This is as per the description, for example, in the passages (0096) and (0097) of Japanese Patent Laid-Open No. 2004-171611.

In the conventional method, where a hologram is recorded in a hologram recording carrier having a reflection surface, the hologram record layer is uselessly employed in its characteristics because four holograms are recorded by the interference between four light fluxes, i.e., incident reference and signal beams and reflecting reference and signal beams. Accordingly, because the reference beam is reflected upon the reflection layer of the hologram record carrier during information reproducing, the reproduced hologram is required to separate it from the reproduced light. This deteriorates the characteristics of reading out a reproduced signal.

Meanwhile, in the conventional method, since many optical components are required to produce and join together the reference and signal beams, the size reduction of the apparatus is desired.

Therefore, the problem that the invention is to solve includes, as one example, to provide an optical pickup apparatus and a hologram recording and reproducing system for hologram recording and reproducing that enables recording or reproducing with stability.

A hologram recording and reproducing system according to the present invention is a system for recording or reproducing information to or from a hologram record carrier that stores an optical interference pattern of a reference beam and a signal beam therein as a diffraction grating, the hologram recording and reproducing system comprising:

light producing means that generates a reference beam and a signal beam based on a coherent beam in which the coherent beam is modulated into the signal beam according to information to be recorded;

interference means that allows one of the reference and signal beams to propagate axially on an optical axis as a central region light flux and allows the other of the reference and signal beams to propagate coaxially and annularly in section as an annular region light flux surrounding the one spatially separated from the other in a same direction and converges both the reference beam and the signal beam on different focal points in the optical axis respectively through an objective lens optical system to cause interference between the reference beam and the signal beam;

a hologram record carrier having a hologram record layer located on a side of a near one of the different focal points to the objective lens optical system and a reflection layer located on a side of a distant one of the different focal points from the objective lens optical system; and

image detecting means arranged on the optical axis and for receiving a beam returning from the hologram record layer through the objective lens optical system when the reference beam is illuminated to the hologram record layer;

wherein the hologram record carrier further comprising a servo guide layer which is placed at a position either nearer to the objective lens optical system than the hologram record layer or farther than the reflection layer from the objective lens optical system,

the hologram recording and reproducing system further comprising a servo control system for focusing a servo beam onto the servo guide layer and for receiving a reflection light returning from the servo guide layer to photoelectrically convert it to a signal and for driving the objective lens optical system in accordance with the signal photoelectrically converted, wherein the servo beam has a wavelength different from the coherent beam wavelength and passes through the central region coaxially with the central region light flux including the optical axis.

In a hologram recording and reproducing system used for hologram recording, a coherent light flux used for hologram recording is divided into a light flux including the optical axis and a light flux annular in section surrounding it, any one of the light fluxes being assigned to a reference beam and the other to a signal beam. The objective lens optical system has two focal lengths for respective the light flux including the optical axis and the annular light flux being different from each other. The objective lens optical system is set up so as to converges the light flux including the optical axis and the annular light flux on the different focal points and at the same time so as to converge the servo beam with a wavelength different from the wavelength of the light flux including the optical axis on the servo guide layer without aberrations.

### BRIEF DESCRIPTION OF THE DRAWINGS

FIGS. 1-3 are schematic fragmentary sectional views showing a hologram record carrier for explaining the conventional hologram recording.

FIG. 4 is a construction view showing a pickup of a hologram apparatus that records/reproduces information to/from a hologram record carrier in an embodiment according to the invention.

FIG. 5 is a front view of a spatial light modulator of the pickup in the embodiment according to the invention, as viewed on the optical axis.

FIG. 6 is a front view of a spatial light modulator of the pickup in another embodiment according to the invention, as viewed on the optical axis.

FIG. 7 is a schematic sectional view showing an objective lens module of the pickup in an embodiment according to the invention.

FIG. 8 is a schematic sectional view showing the hologram record carrier and objective lens module for explaining the hologram recording in the embodiment according to the invention.

FIG. 9 is a schematic sectional view showing the hologram record carrier for explaining the hologram recording in the embodiment according to the invention.

FIG. 10 is a schematic sectional view showing the hologram record carrier and objective lens module for explaining the hologram reproducing in the embodiment according to the invention.

FIG. 11 is a schematic sectional view showing a hologram record carrier and objective lens module for explaining the hologram recording in another embodiment according to the invention.

FIG. 12 is a schematic sectional view showing a hologram record carrier for explaining the hologram recording in another embodiment according to the invention.

FIG. 13 is a schematic sectional view showing an objective lens module of the pickup in another embodiment according to the invention.

FIGS. 14 and 15 are schematic sectional views showing a bifocal lens of an objective lens of a pickup in another embodiment according to the invention.

FIG. 16 is a schematic sectional view showing an objective lens module of a pickup in another embodiment according to the invention.

FIG. 17 is a schematic sectional view showing a hologram record carrier and objective lens module for explaining the hologram recording in another embodiment according to the invention.

FIG. 18 is a schematic sectional view showing a hologram record carrier for explaining the hologram recording in another embodiment according to the invention.

FIG. 19 is a schematic sectional view showing a hologram record carrier and objective lens for explaining the hologram reproducing in another embodiment according to the invention.

FIG. 20 is a schematic sectional view showing a hologram record carrier and objective lens module for explaining the hologram recording in another embodiment according to the invention.

FIG. 21 is a schematic sectional view showing a hologram record carrier for explaining the hologram recording in another embodiment according to the invention.

FIG. 22 is a schematic sectional view showing an objective lens module of a pickup in another embodiment according to the invention.

FIGS. 23 and 24 are schematic sectional views showing a bifocal lens of an objective lens of a pickup in another embodiment according to the invention.

FIG. 25 is a perspective view of a polarizing liquid-crystal panel of a polarization-plane rotating device of the pickup in the embodiment according to the invention.

FIG. 26 is a fragmentary sectional view taken on line X-X in FIG. 25.

FIG. 27 is a perspective view of a polarizing liquid-crystal panel of a polarization-plane rotating device of a pickup in another embodiment according to the invention.

FIG. 28 is a partially-cutaway perspective view of a polarization-plane rotating device of a pickup in another embodiment according to the invention.

FIG. 29 is schematic fragmentary sectional view showing a hologram record carrier in the embodiment according to the invention.

FIG. 30 is a front view of a spatial light modulator of a pickup in another embodiment according to the invention, as viewed on the optical axis.

FIG. 31 is a fragmentary sectional view taken on line X-X in FIG. 26, explaining the state of polarization.

FIG. 32 is a construction diagram showing the outline of a pickup of a hologram apparatus that records/reproduces information to/from a hologram record carrier in another embodiment according to the invention.

FIG. 33 is a block diagram showing a schematic configuration of the hologram apparatus in the embodiment according to the invention.

FIG. 34 is a construction diagram showing the outline of a pickup of a hologram apparatus that records/reproduces information to/from a hologram record carrier in another embodiment according to the invention.

FIGS. 35-39 are schematic sectional views showing a hologram record carrier and objective lens module of a pickup of a hologram apparatus that records/reproduces information to/from a hologram record carrier in another embodiment according to the invention.

FIG. 40 is a construction diagram showing the outline of a pickup of a hologram apparatus that records/reproduces information to/from a hologram record carrier in another embodiment according to the invention.

FIG. 41 is a front view of a polarizing spatial light modulator of a pickup in another embodiment according to the invention, as viewed on the optical axis.

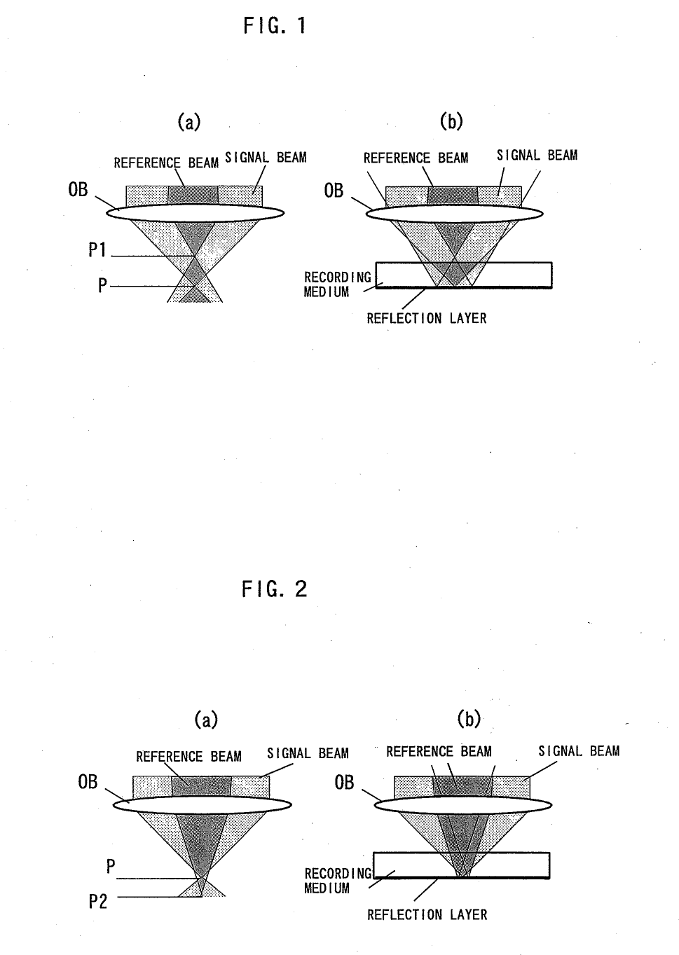

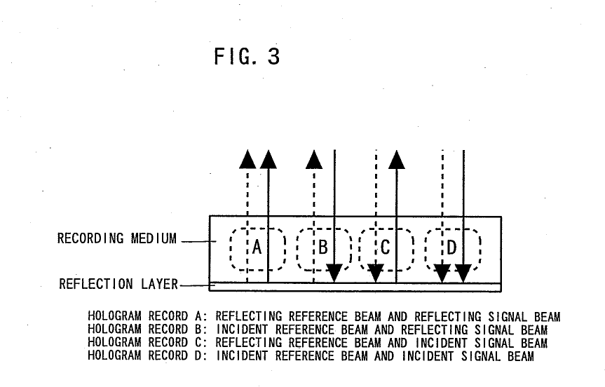

### DETAILED DESCRIPTION OF THE INVENTION

Embodiments of the present invention will be explained from now on while referring to the drawings.

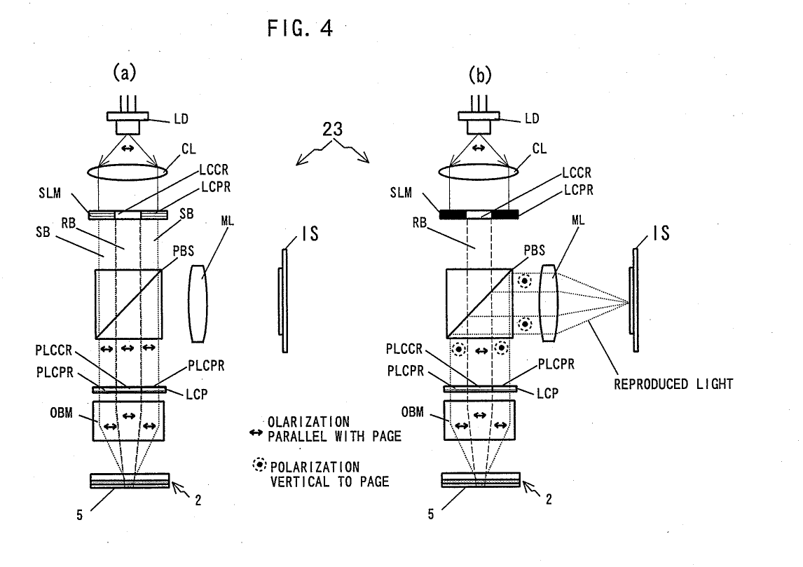

FIG. 4 shows a schematic construction of a pickup 23 for recording and reproducing a hologram record carrier 2.

The Pickup 23 includes laser a laser light source LD for recording and reproducing a hologram, a collimator lens CL, a transmission spatial light modulator SLM, a polarizing beam splitter PBS, an imaging lens ML, an image sensor IS and its drive system (not shown), a transmission polarizing liquid-crystal panel LCP and an objective lens module OBM. Within a casing (not shown), the objective lens module OBM, etc. are arranged on an optical axis of a light flux from the laser light source LD. The laser light source LD has a wavelength at which a light-transmissive photosensitive material is to react that can store an optical interference pattern on the hologram record carrier 2. The collimator lend CL is to change, into a collimated beam, the coherent beam diverging from the laser light source LD.

### ——Spatial Light Modulator——

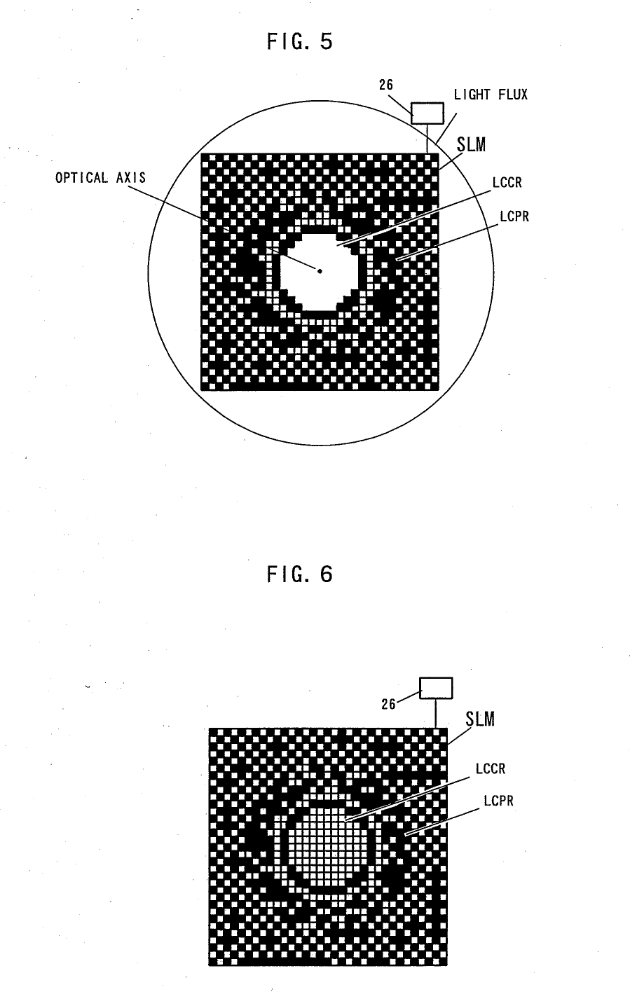

FIG. 5 is a front of the spatial light modulator SLM to be illuminated within the diameter of a collimated light flux, as viewed on the optical axis. The spatial light modulator SLM is divided as a central region LCCR provided closer to and including the optical axis and an annular region LCPR provided around it and not including the optical axis. The central region LCCR is formed by a through-opening or of a transparent material, not to modulate the light flux passing through the same. The light-transmissive annular region LCPR has functions to electrically block a part of the incident light on a pixel-by-pixel basis by means of a liquid-crystal panel with an analyzer having a plurality of pixel electrodes divided in a matrix form or to pass the whole part thereof into a non-modulated state. As shown in FIG. 4, the annular region LCPR is to modulate the collimated beam from the collimator lens CL in accordance with record information. Namely, when passed the spatial light modulator SLM, the light flux is separated concentrically as a signal beam SB spatially modulated and a reference beam RB not spatially modulated.

The spatial light modulator SLM is connected to a spatial-light-modulator drive circuit 26 so that the light flux can be modulated and transmitted to have a distribution based on the page data (information pattern of two-dimensional data such as an on-plane light-and-shade dot pattern) to record therefrom, thereby producing signal beam SB.

Furthermore, as shown in FIG. 6, the spatial light modulator SLM can be wholly structured as a transmission matrix liquid-crystal display device so that it can display a predetermined pattern of recording page data in an annular region LCPR and a non-modulated light transmission region in a central region LCCR at the inner thereof. Incidentally, the central region LCCR can be used as a light transmitting region for phase modulation, i.e., it may produce a phase-modulated reference beam.

As described above, the spatial light modulator SLM has the central region LCCR arranged on the optical axis of a coherent beam and the annular region LCPR arranged in a manner surrounding it, to spatially separate as a transmission component of the coherent beam through the central region and a transmission component through the annular region and produce a reference beam and a signal beam that are propagated coaxially. Although reference and signal beams are produced through the central and annular regions LCCR and LCPR, a signal beam can be produced through the central region LCCR while a reference beam be through the annular region LCPR.

Besides the transmission type one, a reflective liquid-crystal panel or a DMD can be used as an example of the spatial light modulator. In the reflective spatial light modulator, a central region LCCR and an annular region LCPR surrounding it and not including the optical axis are provided similarly to the transmission type, whose function is to separate a light flux as a central region and an annular region.

### ——Objective Lens Optical System——

The objective lens module OBM in FIG. 4 is categorized as an objective lens optical system that illuminates signal and reference beams coaxially toward the hologram record carrier 2 and focuses the reference and signal beams RB, SB on different focal points from each other.

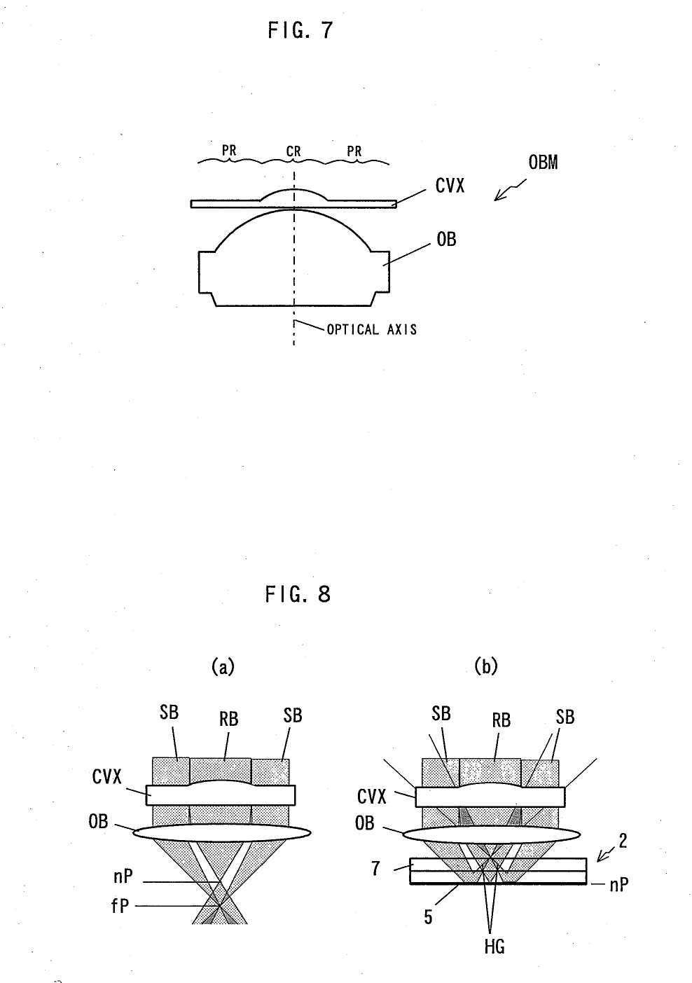

FIG. 7 is a schematic sectional view as an example of an objective lens module OBM. The objective lens module OBM is structured with a convex lens optical element CVX fixed by a hollow holder (not shown) and arranged coaxially with an objective lens OB as a convex lens and a convex lens smaller in diameter than the objective lens OB that are common in optical axis. The convex lens optical element CVX has a central region CR (convex lens) including the optical-axis and an annular region PR (light-transmissive flat plate) surrounding it. As shown in FIG. 8(a), the objective lens module OBM is to focus the transmission light through the central region CR on a near focal point nP in front thereof and to focus the transmission light through the annular region PR on a distant focal point fP located farther therefrom. The near focal point nP is a combined focal point of the objective lens OB and the convex lens optical element CVX while the distant focal point fP is a focal point of the objective lens OB.

In hologram recording, the reference beam RB about the optical axis and the surrounding signal beam SB from the spatial light modulator SLM are guided in a state coaxial to and spatially spaced from each other to the objective lens module OBM, as shown in FIG. 8(a). The spatial light modulator allows the reference beam RB to propagate axially to the central region CR and propagate coaxially the signal beam SB annular in section to the annular region PR surrounding the reference beam RB, spatially separated from each other. The objective lens module OBM refracts the reference beam RB and the signal beam SB respectively at the central region CR and the annular region PR. Accordingly, the reference beam RB and the signal beam SB are spatially separated even after the passage through the objective lens. The reference beam RB is focused on the near focal point nP closer to the objective lens OB and the signal beam SB is on the distant focal point farther than the near focal point, thus causing an interference at a point distant rather than the near focal point nP.

As shown in FIG. 8(b), a reflection layer 5 is arranged in a position of the near focal point nP concerning the reference beam RB while hologram record later 7 is arranged as a recording medium between the objective lens module OBM and the reflection layer 5. The signal beam SB annular in section is reflected by the reflection layer 5 and focused on a point symmetric with the distant focal point fP while the reference beam RB is reflected by the reflection layer 5 in front of the distant focal point fP (at the near focal point nP). Accordingly, by the reflecting and converging signal and reference beams SB, RB opposite in propagation direction to each other, interference state is caused in the annular region in the neighborhood of the optical axis. By using the hologram record carrier having a hologram record layer located between the near focal point nP and the distant focal point fP, the cross angle of the reference and signal beams RB, SB can be taken comparatively great because those are spherical waves propagating in opposite directions to each other, thus making it possible to record, as a hologram HG, an optical interference pattern that can be reduced in multiple spacing. Therefore, the hologram record layer 7 is required having a film thickness sufficient to produce an optical interference pattern due to the interference between the reflecting signal beam and the reference beam.

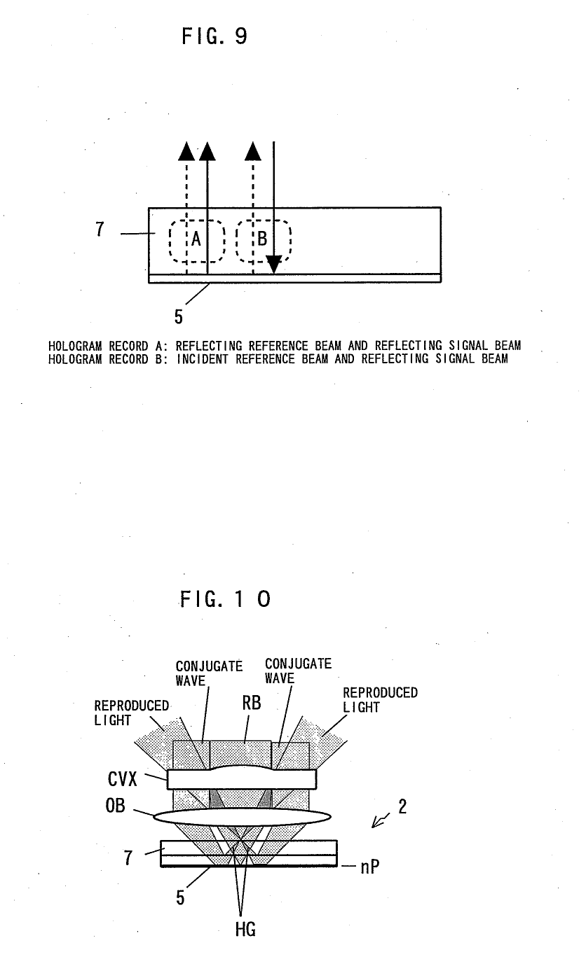

As shown in FIG. 9, the hologram to be concretely recorded are in two types, i.e., hologram record A (a reflecting diverging reference beam and a reflecting converging signal beam) and hologram record B (an incident converging reference beam and a reflecting converging signal beam). Meanwhile, the hologram to be reproduced is also in two types, i.e., hologram record A (to be read out by a reflecting reference beam) and hologram record B (to be read out by an incident reference beam).

Accordingly, in the hologram reproducing system for reproducing information out of the hologram record carrier thus structured, in case the reference beam RB only is supplied to the central region CR of the objective lens module OBM and the reference beam RB is transmitted through a hologram HG of the hologram record layer while being converged to the near focal point nP (reflection layer 5) as shown in FIG. 10, the usual reproduced light and the reproduced light as a phase-conjugate wave are produced from the hologram HG. The reproduced light and the phase-conjugate wave can be guided to a photo-detector by the objective lens OB constituting a part of detecting means.

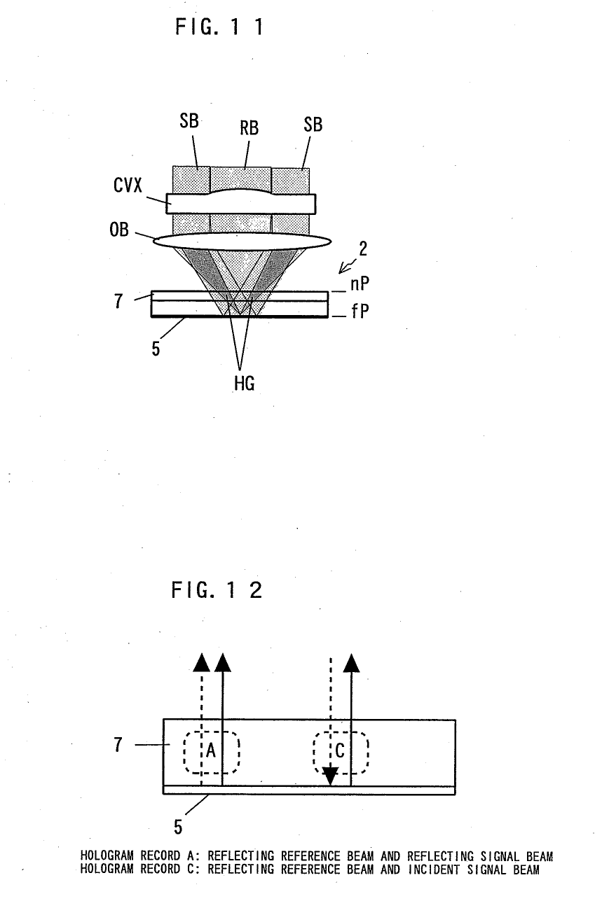

In another hologram recording and reproducing system, the reflection layer 5 is arranged in a position of the distant focal point fP concerning the signal beam SB and the hologram record carrier 2 is arranged such that the hologram record layer 7 lies between the objective lens module OBM and the reflection layer 5 as shown in FIG. 11 instead of arranging the reflection layer 5 in a position of the near focal point nP concerning the reference beam RB. The signal beam SB annular in section is focused on the reflection layer 5 while the reference beam RB is focused in front of the reflection layer 5 (at the near focal point nP) and reflected by the reflection layer 5 while diverging. In this case, on the reflection layer 5, the reference beam RB is in a defocus state while the signal beam SB is in focus. Accordingly, in case the hologram record layer 7 is arranged spaced from the reflection layer 5 such that the signal beam SB has a crossing range only with the reflected reference beam RB, an interference state is obtained in the annular region nearby the optical axis by the signal beam SB and the reference beam RB component that are opposite in propagation directions to each other. As shown in FIG. 12, the hologram to be concretely recorded are in two types, i.e., hologram record A (a reflecting diverging reference beam and a reflecting diverging signal beam) and hologram record C (reflecting diverging reference beam and an incident converging signal beam). Meanwhile, the hologram to be reproduced is also in two types. In the hologram reproducing system in this case, in case the reference beam RB only is supplied to the central region CR of the objective lens module OBM and the reference beam RB is illuminated in a defocus state similarly to that upon recording to the reflection layer 5 and transmitted through the hologram HG, the usual reproduced light and the reproduced light as a phase-conjugate wave can be produced on the same optical path out of the hologram HG.

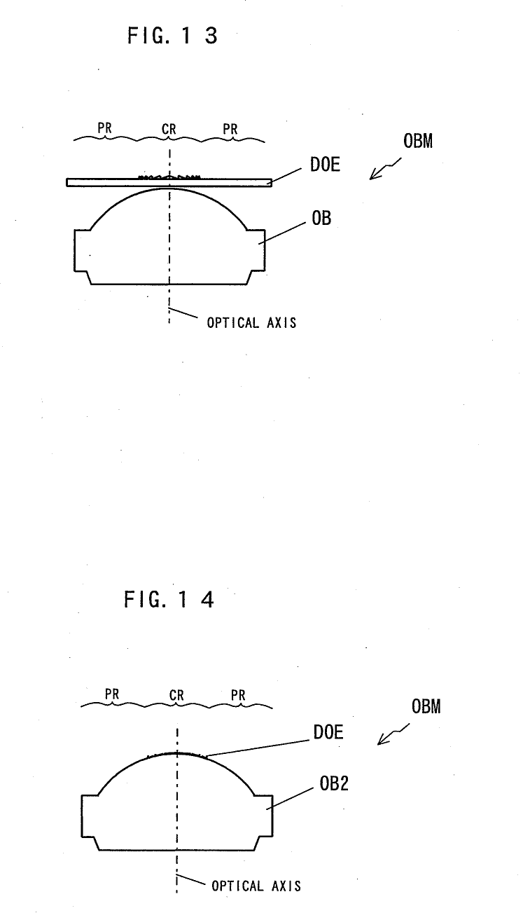

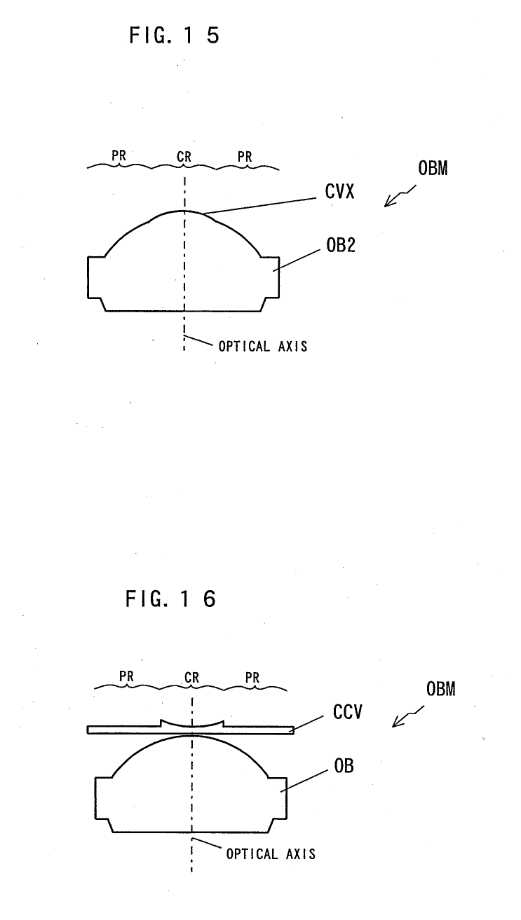

Incidentally, another modification of an objective lens module OBM can be structured by coaxially arranging a transmission-type diffraction optical element DOE having a convex lens function on the optical axis thereof immediately in front of the objective lens OB as shown in FIG. 13 in place of the convex lens optical element. Meanwhile, as shown in FIG. 14, an objective lens OB can be structured in one body with a transmission-type diffraction optical element DOE having a convex lens function. By structuring the objective lens module OBM as a bifocal lens OB2 having a Fresnel surface having a convex lens function coaxially formed in the refraction surface (central region CR) thereof or a diffraction grating DOE, focal length can be provided different between the reference beam RB and the signal beam SB from each other. Furthermore, as shown in FIG. 15, the objective lens module OBM may be structured as a bifocal lens OB2 with aspheric lenses different in radius of curvature from each other by providing a step at the boundary between the central region CR and the annular region PR through integrating the convex lens portion CVX with the objective lens. Furthermore, the bifocal lens may be modified in a form that an annular diffraction grating is provided in the central region CR with a convex lens portion left around it or, conversely, in a form that an annular diffraction grating is provided in the annular region PR with a convex lens portion left in the central region thereof.

The foregoing embodiment was explained on the form that the signal beam around the reference beam is illuminated in a defocus form on the reflection layer by means of the case the signal beam has a focal point farther than the focal point of the reference beam than the objective lens. In addition to that embodiment, even where the focal point of the signal beam SB lies in front of the focal point of the reference beam, such a defocus state can be achieved. For example, FIG. 16 shows a structural example of an objective lens optical system according to another embodiment.

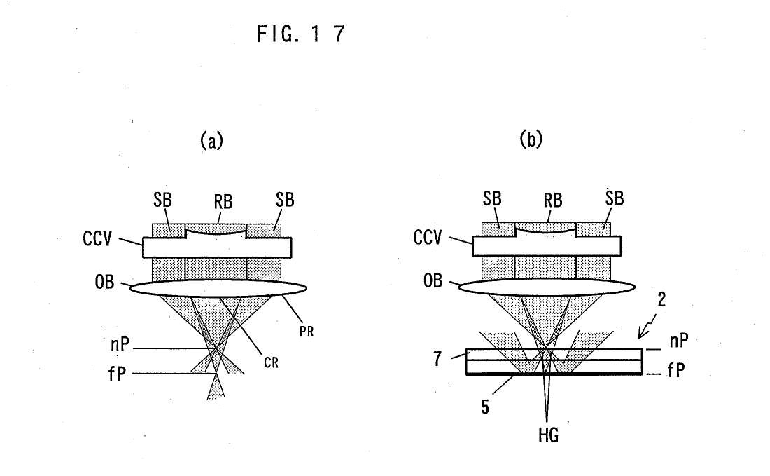

The objective lens module OBM of FIG. 16 is structured with a concave lens optical element CCV fixed by a hollow holder (not shown) or the like and arranged coaxially with a convex objective lens OB and a concave lens smaller in diameter than the objective lens OB that are common in optical axis. The concave lens optical element CCV is formed with a central region CR (concave lens) including the optical axis and an annular region PR (light-transmission flat plate) around the same. The objective lens module OBM is to focus the transmission light through the central region CR on a distant focal point fP and the transmission light through the annular region PR on a near focal point nP in front thereof as shown in FIG. 17(a). The distant focal point fP is a combined focal point of the objective lens OB and the concave lens optical element CCV while the near focal point nP is a focal point of the objective lens OB.

In hologram recording, first produced are a reference beam RB coherent about the optical axis and the surrounding signal beam SB obtained by modulating the reference beam RB in accordance with record information, by means of the spatial light modulator or the like coaxial to the objective lens module OBM. As shown in FIG. 17(a), the reference beam RB and the signal beam SB are guided to the objective lens module OBM, in a state coaxial to and spatially spaced from each other. The objective lens module OBM refracts the reference and signal beams RB, SB respectively at central and annular regions CR, PR. Accordingly, even after passed the objective lens, the reference beam RB and the signal beam SB are spatially separated. The signal beam SB is focused on a near focal point nP closer to the objective lens OB while the reference beam RB is focused on a distant focal point farther than the near focal point.

In hologram recording, first a coherent reference beam RB and a signal beam SB are produced, the signal beam SB being obtained by modulating the reference beam RB in accordance with record information.

The reference beam RB and the signal beam SB are guided to the objective lens module OBM in a manner coaxial to and spatially separated from each other. Namely, as shown in FIG. 17(a), the reference beam RB is propagated axially to the central region CR and the signal beam SB to the annular region PR surrounding the reference beam RB, spatially separated and coaxially to each other. Even after the passage through the objective lens, the reference beam RB and the signal beams SB are spatially separated. The signal beam SB is focused on a near focal point nP closer to the objective lens module OBM while the reference beam RB is focused on a distant focal point fP farther than the near focal point.

As shown in FIG. 17(b), the reflection layer 5 is arranged in a position of the distant focal point fP concerning the reference beam RB while the hologram record layer 7 is arranged between the objective lens module OBM and the reflection layer 5. The signal beam SB annular in section is focused in front of the reflection layer 5 (at the near focal point nP) and reflected by the reflection layer 5 while diverging. The reference beam RB is focused on and reflected by the reflection layer 5. Accordingly, the signal beam SB annular in section is focused in front of the reflection layer 5 and hence defocused at the reflection layer 5. The reflected signal beam SB does not cross with the reference beam RB, thus being not in a state of interference. Because the cross angle of the incident reference and signal beams RB, SB can be taken comparatively great, multiple spacing can be reduced.

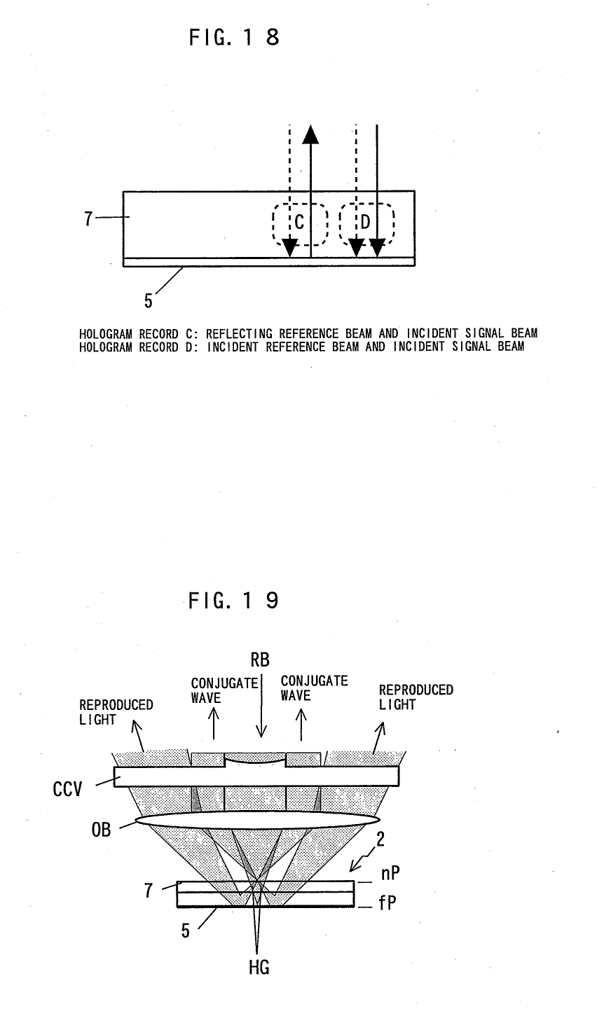

As shown in FIG. 18, the hologram to be concretely recorded are in two types, i.e., hologram record C (a reflecting diverging reference beam and an incident converging signal beam) and hologram record D (an incident converging reference beam and an incident converging signal beam). Meanwhile, the hologram to be reproduced is also in two types.

Accordingly, in the hologram reproducing system for reproducing information out of the hologram record carrier, as shown in FIG. 19, in case the reference beam RB only is supplied to the central region CR of the object lens module OBM and the reference beam RB is transmitted through the hologram HG of the hologram record layer while being converged to the reflection layer 5 (distant focal point fP), the usual reproduced light and the reproduced light as a phase-conjugate wave are produced from the hologram HG. The reproduced light and the phase-conjugate wave can be guided to the photodetector by the objective lens OB also constituting a part of detecting means.

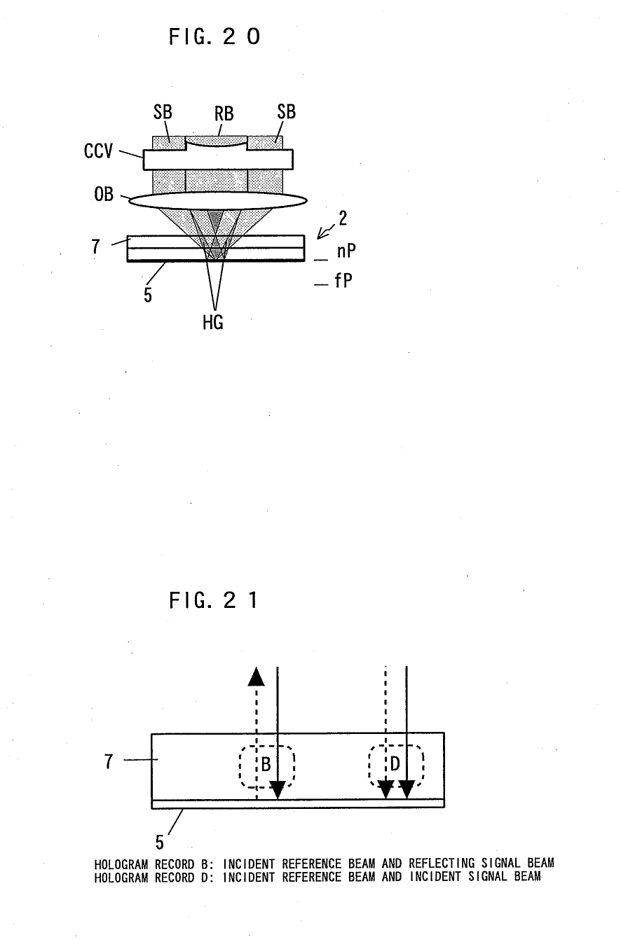

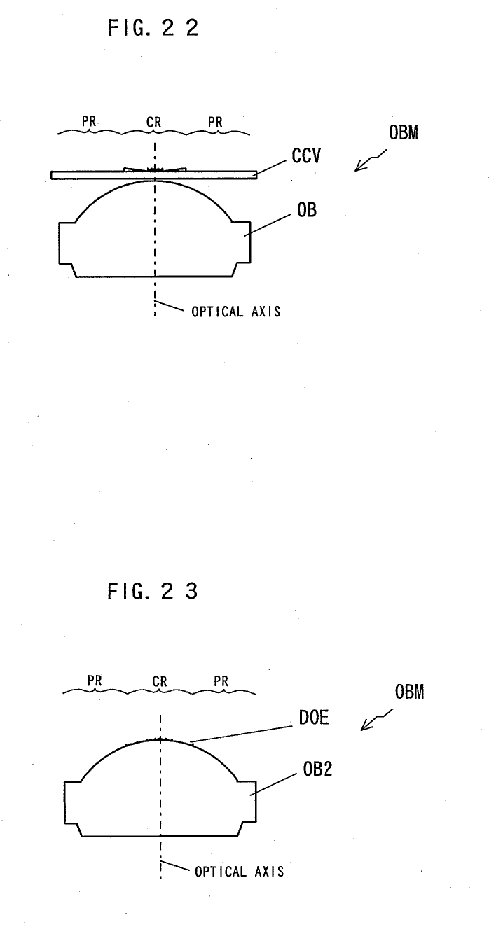

In another hologram recording and reproducing system, instead of arranging the reflection layer 5 in a position of the distant focal point fp concerning the reference beam RB and arranging the hologram record layer 7 between the objective lens module OBM and the reflection layer 5, the reflection layer 5 is arranged in a position of the near focal point nP concerning the signal beam SB transmitted through the annular region PR as shown in FIG. 20 while the hologram record carrier 2 is arranged such that the hologram record layer 7 lies between the objective lens module OBM and the reflection layer 5. The signal beam SB annular in section is focused on and reflected by the reflection layer 5 while the reference beam RB is reflected by the reflection layer 5 and focused on a position symmetric with the distant focal point fP. In this case, on the reflection layer 5, the reference beam RB is in a defocus state while the signal beam SB is in focus. As shown in FIG. 21, the hologram to be concretely recorded are in two types, i.e., hologram record B (an incident reference beam and a reflecting signal beam) and hologram record C (an incident reference beam and an incident signal beam). Meanwhile, the hologram to be reproduced is also in two types. In the hologram reproducing system in this case, in case the reference beam RB only is supplied to the central region CR of the objective lens module OBM and the reference beam RB is illuminated in a defocus state similarly to that upon recording to the reflection layer 5 and transmitted through the hologram HG of the hologram recording layer, the usual reproduced light and the reproduced light as a phase-conjugate wave can be produced on the same optical path out of the hologram HG.

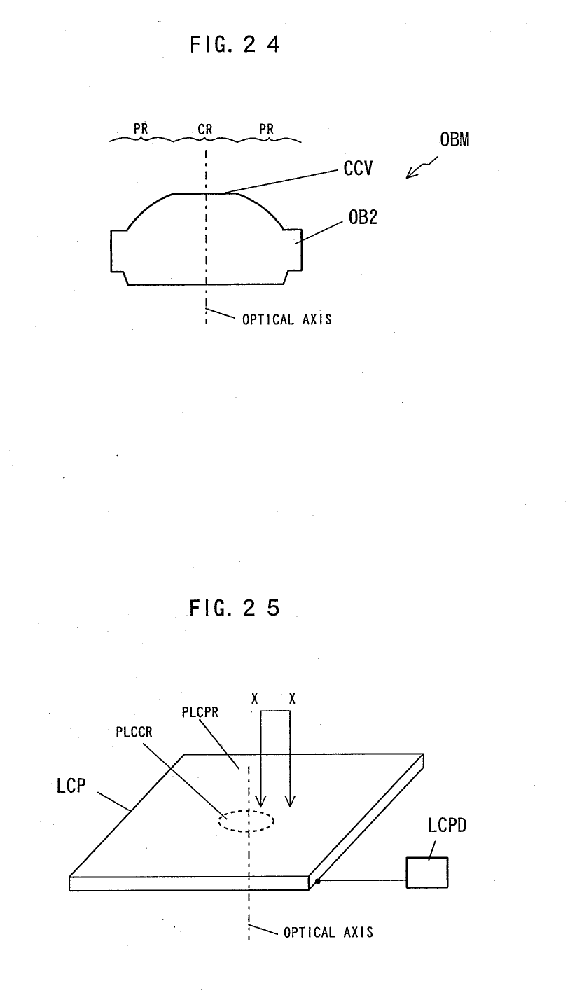

Furthermore, as for another modification of a bifocal objective lens module OBM, the reference beam RB and the signal beam SB can be provided different in focal length from each other by forming the transmission-type diffraction optical element DOE centrally having a concave lens function as an objective lens module arranged immediately in front of the objective lens OB, as shown in FIG. 22. Meanwhile, as shown in FIG. 23, by structuring the objective lens OB and the transmission-type diffraction optical element DOE in one body into a bifocal lens OB2 (having a Fresnel surface or diffraction grating DOE having a concave lens function coaxially formed in the central region CR of the refractive surface thereof), the reference beam RB and the signal beam SB can be made different in focal length from each other. Meanwhile, in place of lens-integrated diffraction grating, the objective lens module OBM may be structured as an bifocal lens OB2 having aspheric lenses different in curvature from each other by providing a step in the boundary between the central region CR and the annular region PR through forming the concave lens portion CCV in one body as shown in FIG. 24.

By structurally propagating and illuminating the reference and signal beams coaxially about any one thereof with the other separated in a surrounding manner, the reference and signal beams can be restricted from overlapping to a certain degree upon incidence.

Meanwhile, in the embodiment shown in FIGS. 8 and 17, the reference beam focused on the reflection layer can be used as a light flux for servo error detection. Furthermore, the embodiment shown in FIGS. 11 and 20 is to produce a reference beam at the center and a signal beam at the outer peripheral annular region. However, if this is modified to produce a signal beam at the central region and a reference beam at the outer peripheral annular region, the reference beam annular in section focused on the reflection layer can be used as a light flux for servo error detection.

According to the foregoing embodiments and modifications, there is no possibility to record/reproduce useless holograms because interfering signal and reference beams are restricted upon hologram recording. Meanwhile, because the reference beam RB and the signal beam SB are spheric waves propagating in opposite directions to each other, the crossing angle thereof can be taken comparatively great, thus enabling shift multiplex and reducing multiple spacing.

### ——Image Detecting Means——

The polarizing beam splitter PBS, imaging lens ML and image sensor IS, arranged on the optical axis in FIG. 4, serve as image detecting means that receives the return light from the hologram record carrier 2 through the objective lens module OBM upon illuminating the reference beam to the hologram record layer. The image sensor IS is a photoelectric converting device formed by the array of CCDs (charge coupled devices) or CMOSs (complementary metal-oxide-filmed semiconductor).

### ——Polarizing Liquid-Crystal Panel——

The transmission polarizing liquid-crystal panel LCP, in FIG. 4, is a liquid-crystal device including a central polarizing region PLCCR arranged on the optical axis and an annular polarizing region PLCPR arranged in a manner surrounding it, and wherein the transmission components through the central and annular polarizing regions PLCCR, PLCPR can be made different in the rotation angle on the polarization plane from each other.

The polarizing liquid-crystal panel LCP is connected to a polarization-liquid-crystal drive circuit LCPD so that the relevant circuit can control to rotate the polarization planes of the signal beam passing through the annular region and the reference beam passing through the central region inner thereof and to switch over the rotary angle thereof from upon hologram recording to upon reproducing. The polarization liquid-crystal drive circuit LCPD and polarizing liquid-crystal panel LCP are a system capable of rotating a predetermined angle, e.g., 90 degrees, the polarization direction of the portion through the annular region and the inner portion through the central region of the light flux emitted from the laser light source.

As shown in FIG. 25, the polarizing liquid-crystal panel LCP is a transmission liquid-crystal device connected to the polarization liquid-crystal drive circuit LCPD. The polarization liquid-crystal drive circuit LCPD includes an annular polarizing region PLCPR and the inner central polarizing region PLCCR. The polarization liquid-crystal panel LCP, during hologram recording, is rendered in a state of light transmission that polarization is provided identical through the both regions and, during reproducing, is rendered in a state of polarization activation different between the regions by the polarization liquid-crystal drive circuit LCPD. In this manner, the central polarizing region PLCCR is structured as a region where the reference beam RB only is allowed to pass while the annular polarizing region PLCPR is separately as a region where the signal beam SB only is allowed to pass.

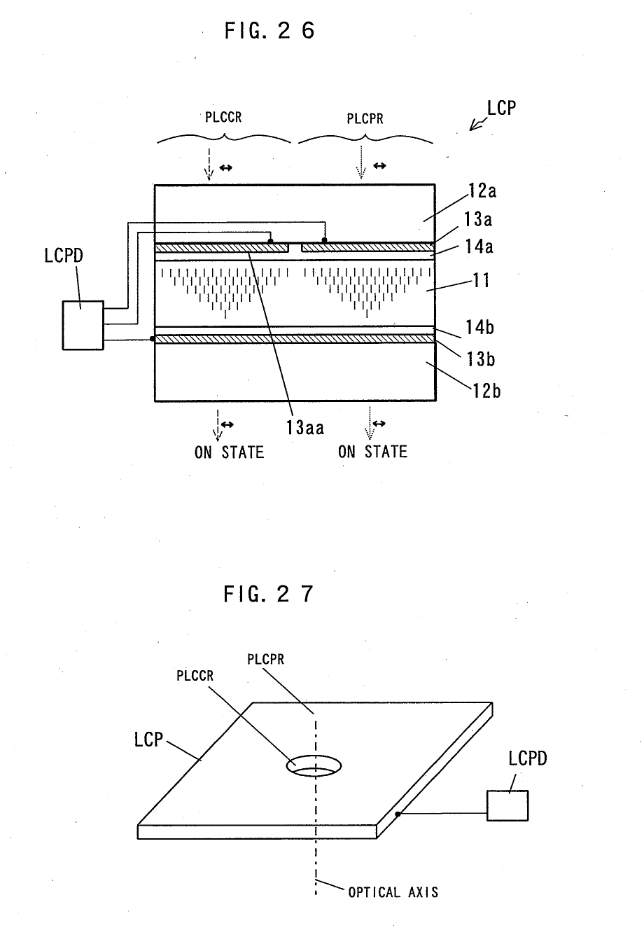

As shown in FIG. 26, the polarizing liquid-crystal panel LCP has a structure that a fluidal transparent liquid-crystal composition-of-matter 11 is sandwiched between two glass substrates 12a, 12b wherein seal is made in the periphery of the substrates. On the inner surfaces of the respective glass substrates 12a, 12b, there are laid in order a transparent electrode 13aa, 13a, 13b formed of an indium-tin oxide, etc. and for applying voltage to the liquid crystal and an alignment film 14a, 14b for regulating the direction (orientation) of the axes of the neighboring liquid-crystal molecules. Although a transparent electrode 13b is a common electrode, transparent electrodes 13a, 13aa are separately arranged in the annular polarizing region PLCPR and the inner central polarizing region PLCCR. Those are to be independently applied with voltages by means of the polarization liquid-crystal drive circuit LCPD. In this manner, the transparent electrodes 13a, 13aa define annular and central polarizing regions PLCPR, PLCCR.

Liquid crystal is a substance having elongate molecules that exhibit an intermediate phase of solid and liquid and have both regularity and irregularity in positions and axial directions thereof. In the natural state (free of applied electric field), liquid-crystal molecules are generally arranged along the major axes thereof with moderate regularity. In case liquid-crystal molecules are put in contact with an alignment film inscribed with a plurality of fine grooves in a given direction by rubbing or so, liquid-crystal molecules have a nature to rearrange at their molecular axes along the grooves. In TN (twisted nematic) liquid crystal, where a liquid crystal is filled between two alignment films arranged parallel with a predetermined spacing such that the fine grooves are in a direction of 90 degrees, liquid-crystal molecules are arranged (helically arranged) in a manner rotating through 90 degrees while gradually twisting from one alignment film to the other alignment film. In case light is transmitted through the liquid crystal from one alignment film to the other alignment film in the state the liquid-crystal molecules are oriented in a twisted form, the light is passed along the gaps between the arranged liquid-crystal molecules. For example, the linearly polarized light parallel with the axes of the liquid-crystal molecules existing close to one alignment film is turned into a linearly polarized light parallel with the axes of the liquid-crystal molecules existing close to the other alignment film, thus being allowed to transmit with the oscillation plane (polarization plane) twisted 90 degrees (off state that no voltage is applied).

Meanwhile, when voltage is applied to between the opposite transparent electrodes sandwiching the liquid crystal, liquid-crystal molecules change the axes from the direction along the alignment film into a vertical direction, thus being oriented along the electric field. Because liquid-crystal molecules rise upright from the alignment film and change the arrangements, linearly polarized transmission light is not rotated in its polarization plane (parallel with the paper) but allowed to pass directly without polarization (on state that the same voltage is applied), as shown in FIG. 26.

As for a modification to the polarizing liquid-crystal panel LCP, where there is a no need to switch the polarization direction of a light flux transmitting through the central polarizing region PLCCR surrounded by the annular polarizing region PLCPR of a polarizing liquid-crystal panel LCP, the central polarizing region PLCCR can be structured by a physical through-opening or a transparent material filled therein as shown in FIG. 27.

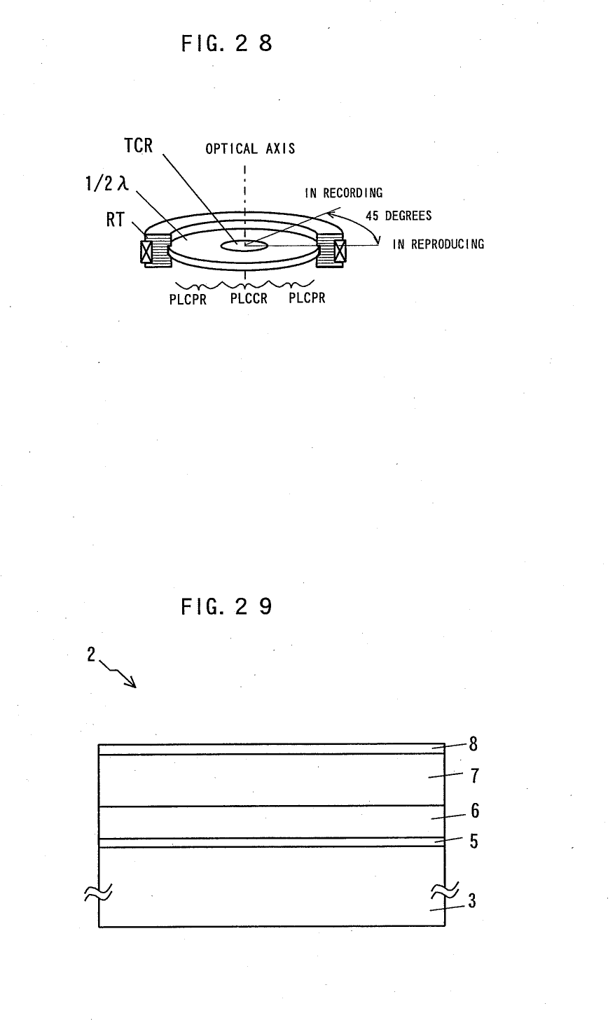

The polarizing liquid-crystal panel LCP is one of polarization-plane rotating devices, i.e., those utilizing polarization switches. There is a polarization-plane rotating device using a ½-wavelength plate, as another embodiment of the system capable of rotating 90 degrees the polarization direction of a light flux at its annular-region light flux portion and the inner central-region light flux portion emitted from a laser light source other than a polarizing liquid-crystal panel LCP. FIG. 28 shows an example of the polarization-plane rotating device. The polarization-plane rotating device is structured with an annular ½-wavelength plate ½λ having a major surface aligned at its normal line with the optical axis and for transmitting a light flux portion through the annular region and an inner through-opening or transparent material TCR filled therein including the optical axis and for transmitting a light flux portion through the central region. The polarization-plane rotating device has a retaining mechanism RT for rotating the annular ½-wavelength plate ½λ about the central optical axis. By electrically controlling the retaining mechanism by means of an electromagnetic actuator, 45-degree rotation can be caused about the optical axis thus switching the polarization plane upon hologram recording and reproducing. Besides, the polarization plane can be switched upon hologram recording and reproducing by advancing and retracting the annular ½-wavelength plate ½λ onto and from the optical axis.

### ——Hologram Record Carrier——

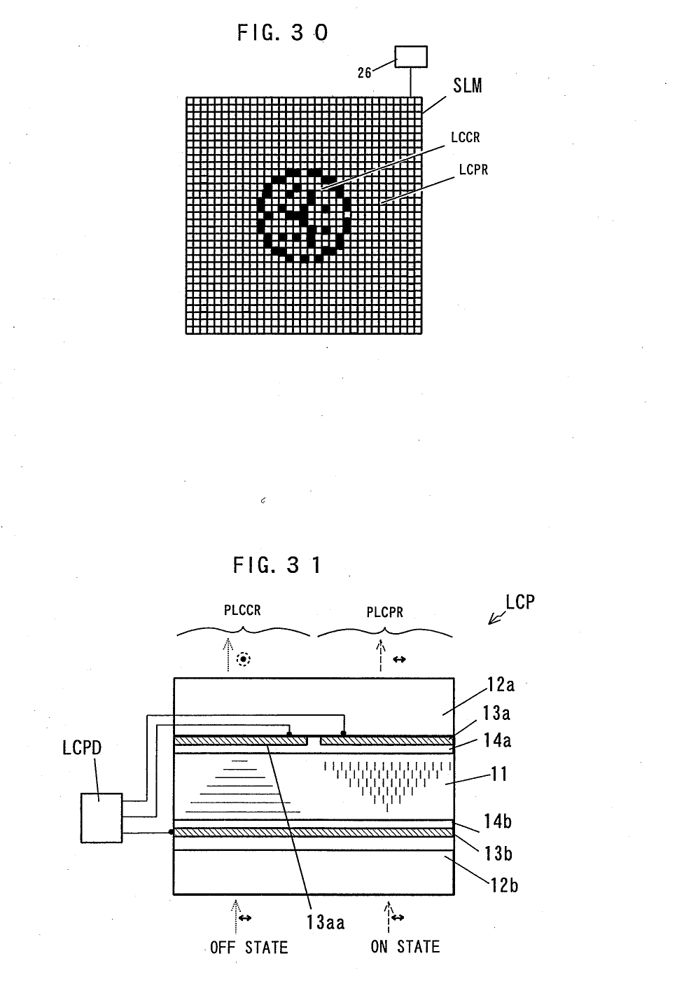

FIG. 29 shows an example of the FIG. 4 hologram record carrier 2. The hologram record carrier 2 is structured with a reflection layer 5, a separation layer 6, a hologram record layer 7 and a protection layer 8 that are laid in a direction of film thickness on a substrate 3.

The hologram record layer 7 is to internally store, as a diffraction grating (hologram), an optical interference pattern caused by coherent reference and signal beams RB, SB for recording. The hologram record layer 7 uses a light-transmissive photosensitive material capable of storing an optical interference pattern, e.g., photopolymer, photoanisotropic material, photo-refractive material, hole burning material or photochromic material.

The substrate 3, carrying the films, is formed of glass, plastic such as polycarbonate, amorphous polyolefin, polyimide, PET, PEN or PES, UV-set acrylic resin or the like.

The separation layer 6 and the protection layer 8 are formed of a light-transmissive material having a role to planarize the overlay structure and to protect the hologram record layer or the like.

Where the substrate 3 is a disk, a track can be formed spiral, concentric or in a plurality of segmented spiral arcs about the center of the disk. Incidentally, in the case the substrate 3 is in a card form, a track may be formed parallel on the substrate. Even if a rectangular-card substrate 3, a track may be formed spirally, spirally arcuately or concentrically about, for example, the substrate center of gravity.

### ——Record/Reproduce Operation——

Explanation is made on the record/reproduce operation of the embodiment of FIG. 4.

In record operation, as shown in FIG. 4(a), the laser beam having a polarization parallel with the paper, from the laser light source LD, is changed into a collimated light flux by the collimator lens CL and then transmitted through the spatial light modulator SLM where divided as a light flux including the optical axis and a light flux annular in section surrounding it. The light flux including the optical axis is produced as a reference beam RB while the light flux annular in section is as a signal beam SB. The reference beam RB and the signal beam SB are coaxially transmitted through the polarizing beam splitter PBS and polarizing liquid-crystal panel LPC, and focused on the hologram record carrier 2 by the objective lens module OBM. During hologram recording, the polarizing liquid-crystal panel LCP is placed entirely in on-state at the region where the reference beam RB only is to pass (central polarizing region PLCCR) and at the region where the signal beam SB only is to pass (annular polarizing region PLCPR), thus being set up to make the polarization states of the signal and reference beams SB, RB identical (in a direction parallel with the paper). This accordingly makes a recording in the hologram record layer 7 of the hologram record carrier 2 by the interference between the signal beam SB and the reference beam SB.

In reproduce operation, as shown in FIG. 4(b), only a light flux (reference beam RB) including the optical axis is produced at the spatial light modulator SLM from a light flux having a polarization direction parallel with the paper. When the reference beam RB is transmitted through the polarizing beam splitter PBS and polarizing liquid-crystal panel LCP and focused on the hologram record carrier 2 through the objective lens module OBM, reproduced light is reconstructed having a polarization parallel with the paper. During reproducing, the central polarizing region PLCCR of the polarizing liquid-crystal panel LCP is placed in on-state and the annular polarizing region PLCPR is in off-state, thus making a setting to make the transmission light through the annular polarizing region PLCPR and the transmission light through the central polarizing region PLCCR different approximately 90 degrees in the polarization state. The reproduced light, by the reference beam RB, is a diverging and converging light flux same as the signal beam upon recording and in a polarization direction parallel with the paper. However, the reproduced light undergoes the polarizing action due to the polarizing liquid-crystal panel LCP because of passing through the annular polarizing region PLCPR of the polarizing liquid-crystal panel LCP, the polarization of which is in a direction vertical to the paper. Meanwhile, the reference beam RB remaining parallel with the paper is reflected by the reflection layer 5, thus not undergoing a polarizing action at the polarizing liquid-crystal panel LCP. Accordingly, the reference beam RB reflected by the reflection layer 5 upon reproducing and the light to be reproduced are different in polarization direction and hence can be separated by means of the polarizing beam splitter PBS. Because no reference beam RB is incident upon the detector for detecting the light to reproduce, reproduction SN improves.

The component, polarized vertical to the paper by the polarizing liquid-crystal panel LCP (transmitting light flux rotated 90 degrees in polarization direction by the polarizing liquid-crystal panel LCP) and reflected by the polarizing beam splitter PBS, is incident upon the image sensor IS. The image sensor IS delivers an output, corresponding to the image focused with the reproduced light, to a reproduced-signal detecting circuit (not shown) where processing is made to reproduce page data.

In this manner, in the pickup for use in hologram recording, the hologram-record light flux is divided as a light flux (reference beam) closer to and including the optical axis and an annular-sectioned light flux (signal beam) surrounding it. The pickup has objective lens optical system (lens group) having a focal length different between the signal beam and the reference beam, and further a polarizing liquid-crystal panel LCP arranged between the spatial light modulator SLM and the objective lens OB. The polarizing liquid-crystal panel LCP has the central polarizing region PLCCR and the annular polarizing region PLCPR, the dividing form of which is nearly equal to the cross-sectional form of a light flux (reference beam) to transmit and including the optical axis and an annular light flux (signal beam) surrounding it.

### ——Modifications——

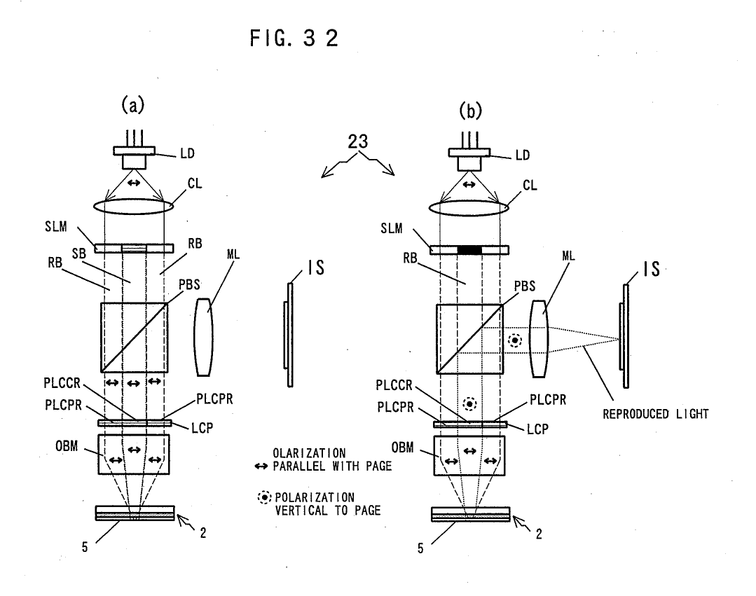

The TN polarizing liquid-crystal panel LCP is capable of changing the polarization direction of a transmitting light flux on each of the central polarizing region PLCCR and the annular polarizing region PLCPR, depending upon the state of voltage application. By the polarizing liquid-crystal panel LCP, the signal beam SB and the reference beam RB are made identical in polarization state within the hologram record layer 7 during hologram recording whereas those are made different approximately 90 degrees from each other during reproducing. Accordingly, in a modification, the structure of the polarizing liquid-crystal panel LCP and spatial light modulator SLM makes it possible to produce and propagate a signal beam on the optical axis and a reference beam around it, instead of propagating a reference beam on the optical axis and a signal beam around it. In this case, as shown in FIG. 30, the spatial light modulator SLM can be wholly structured as a transmission matrix liquid-crystal display device to display, by means of the control circuit 26, a central region LCCR for displaying a predetermined pattern of page data to record and the surrounding annular region LCPR, surrounding it, for displaying a non-modulated light-transmissive region. Incidentally, the non-modulating light-transmissive region in the annular region LCPR can be formed of a transparent material. Furthermore, in the polarizing liquid-crystal panel LCP, the polarization liquid-crystal drive circuit LCPD provides the both regions with the same polarization of light-transmission state during hologram recording. During reproducing, it provides different polarizing states to the central polarizing region PLCCR (off-state) and the annular polarizing region PLCPR (on-state) of the polarizing liquid-crystal panel LCP, as shown in FIG. 31. In this case, as shown in FIG. 32(a), the collimated beam flux transmitted through the spatial light modulator SLM is divided and produced as a signal beam SB (light flux including the optical axis) and a reference beam RB as a light flux annular in section surrounding it, to pass through the polarizing beam splitter PBS and the polarizing liquid-crystal panel LCP. The operations of record (FIG. 32(a)) and reproduce (FIG. 32(b)) are similar to the above example excepting in that the reference beam and the signal beam are different in propagating position. For the modification case, such a structure of the objective lens module OBM as shown in FIGS. 8 to 24 can be applied.

According to the above embodiments, because the reflecting reference beam RB is separated or not focused during reproducing, the reference beam RB is not to reach the image sensor IS thus making it possible to receive only the hologram-reproduced light required for reproducing a signal. As a result, a SN ratio in the reproducing step is improved to enable stable reproducing.

Servo control, though not shown, is made available by providing a track on the reflection layer 5, focusing the reference beam RB as a spot on the track, and driving the objective lens optical system by an actuator in accordance with a servo error signal detected with use of a servo optical system including an objective lens for leading the reflection light to a photodetector. Namely, the light flux of reference beam RB, illuminated from the objective lens, is used in a manner focused when the reflection layer 5 is in a position of the beam waist.

### ——Hologram Apparatus——

As another embodiment, the hologram apparatus is explained as a hologram recording and reproducing system of the invention that records and reproduces the information of the hologram record carrier in a disk form.

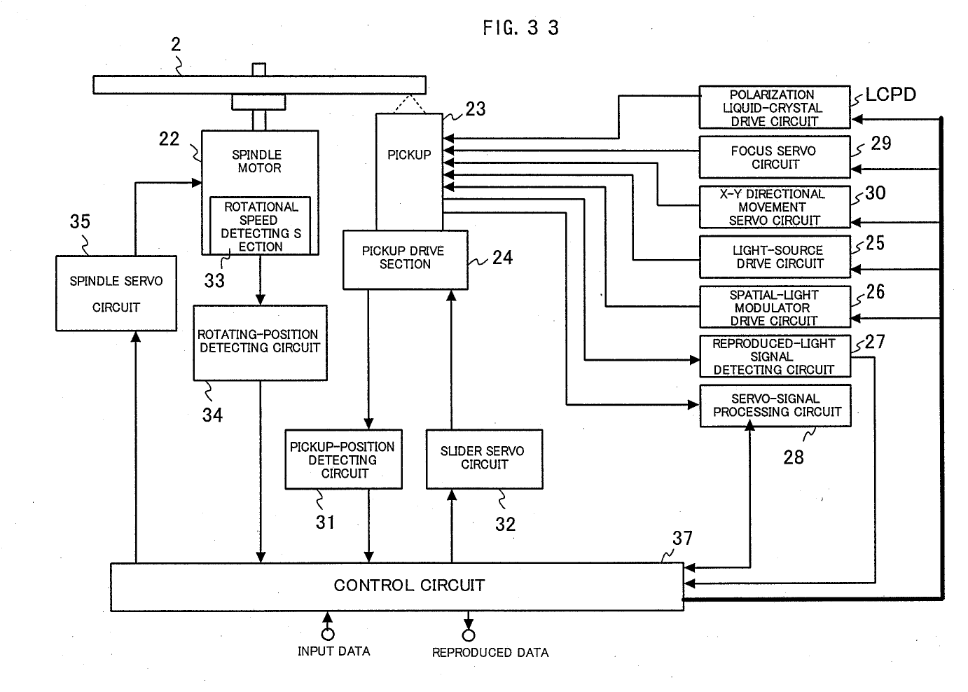

FIG. 33 is a block diagram as an example of the hologram apparatus.

The hologram apparatus has a spindle motor 22 for rotating the disk of the hologram record carrier 2 by means of a turntable, a pickup 23 for reading a signal out of the hologram record carrier 2 by means of a light flux, a pickup drive section 24 for holding the pickup and moving it in the radial direction (in the x direction), a light-source drive circuit 25, a spatial-light-modulator drive circuit 26, a reproduced-light signal detecting circuit 27, a servo signal processing circuit 28, a focus servo circuit 29, an xy-direction movement servo circuit 30, a pickup-position detecting circuit 31 connected to the pickup drive section 24 and for detecting a position signal as to the pickup, a slider servo circuit 32 connected to the pickup drive section 24 and for supplying a predetermined signal to it, a rotational-speed detecting section 33 connected to the spindle motor 22 and for detecting the rotational-speed signal concerning the spindle motor, a rotating-position detecting circuit 34 connected to the rotational-speed detecting section and for producing a rotating-position signal as to the hologram record carrier 2, and a spindle servo circuit 35 connected to the polarization liquid-crystal drive circuit LCPD and spindle motor 22 and for supplying a predetermined signal to those.

The hologram apparatus has a control circuit 37. The control circuit 37 is connected to the light-source drive circuit 25, the spatial-light-modulator drive circuit 26, the reproduced-light signal detecting circuit 27, the servo signal processing circuit 28, the focus servo circuit 29, the xy-direction movement servo circuit 30, the pickup-position detecting circuit 31, the slider servo circuit 32, the rotational-speed detecting section 33, the rotating-position detecting circuit 34, the polarization liquid-crystal drive circuit LCPD and the spindle servo circuit 35. Based on the signals from those circuits, the control circuit 37 performs focus servo control, x-and-y direction movement servo control, reproducing position (position in x and y directions) control as to the pickup through the drive circuits. The control circuit 37 is made up by a microcomputer mounted with various memories and for taking control of apparatus overall. In accordance with user's operation input through an operating section (not shown) and current apparatus operating status, various control signals are produced. In addition, connection is made to a display section (not shown) that displays an operating status, etc. for the user.

The light-source drive circuit 25, connected to the hologram recording and reproducing laser light source LD1, regulates the output of the laser light source LD1 in a manner increasing the intensity of both light fluxes to emit during hologram recording and decreasing it during reproducing.

Meanwhile, the control circuit 37 carries out processing such as encoding of the data, to be hologram-recorded, inputted externally, to supply a predetermined signal to the spatial-light-modulator drive circuit 26 and controls the hologram record sequence. The control circuit 37 performs demodulation and error correction based on the signal from the reproduced-light signal detecting circuit 27 connected to the image sensor IS, thereby restoring the data recorded on the hologram record carrier. Furthermore, the control circuit 37 performs a decode process on the restored data thereby reproducing information data and outputting it as reproduced information data.

Furthermore, the control circuit 37 takes control to form holograms at a predetermined interval so that holograms to record can be recorded at a predetermined interval (multiple spacing).

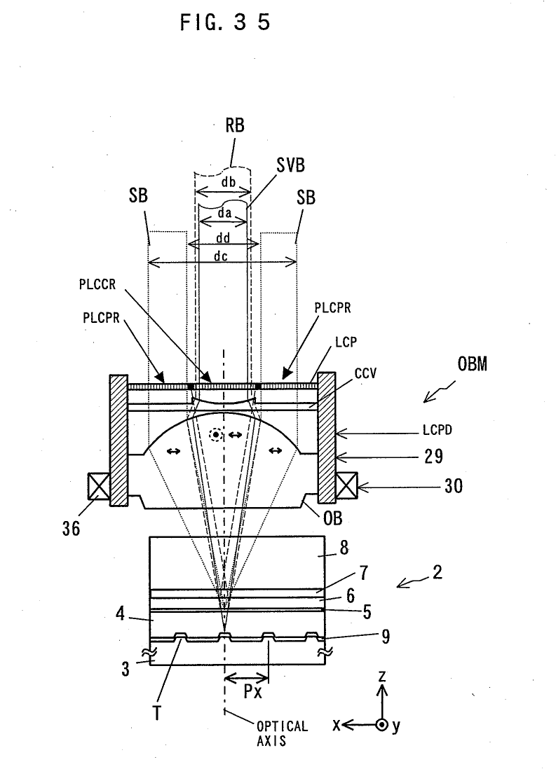

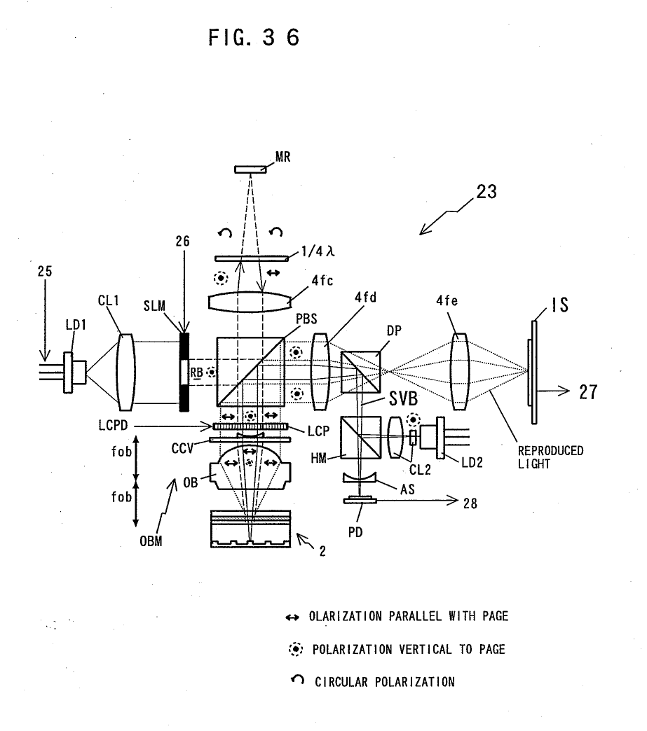

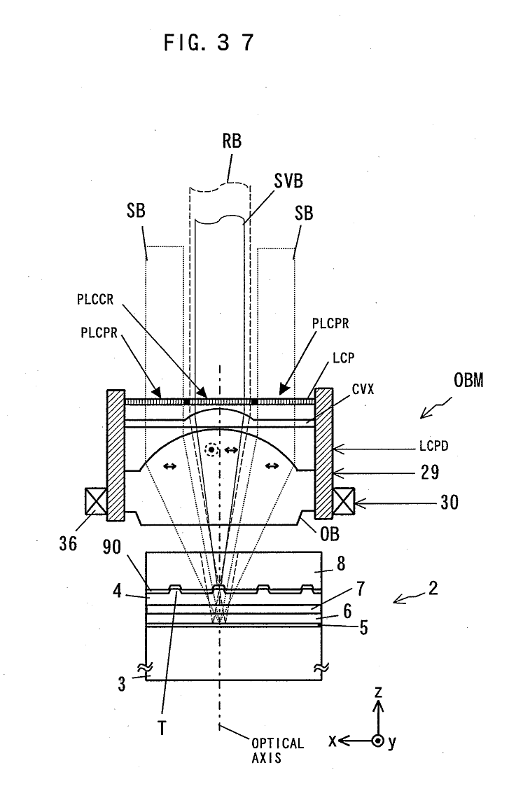

The servo-signal processing circuit 28 produces, from a focus error signal, a focusing drive signal that is supplied to the focus servo circuit 29 through the control circuit 37. In accordance with a drive signal, the focus servo circuit 29 drives a focusing part of the objective lens drive section 36 (see FIG. 35) mounted on the pickup 23. The focusing part operates to adjust the focal point of a light spot to be illuminated to the hologram record carrier.

Furthermore, the servo-signal processing circuit 28 generates x and y direction-movement drive signals and supplies those to the xy-direction movement servo circuit 30. The xy-direction movement servo circuit 30 drives the objective lens drive section 36 (see FIG. 35) mounted on the pickup 23 in accordance with the x and y direction movement drive signals. Accordingly, the objective lens is driven in an amount commensurate with the drive current based on the x-and-y directional drive signals, to change the position of the light spot illuminated to the hologram record carrier. This enables to make constant the relative position of the light spot to the hologram record carrier in moving during recording, thus securing the forming time of hologram.

The control circuit 37 produces a slider drive signal depending upon the position signal from the operating section or pickup-position detecting circuit 31 and the x-direction error signal from the servo-signal processing circuit 28, and supplies those to the slider servo circuit 32. The slider servo circuit 32 causes, through the pickup drive section 24, the pickup 23 to displace radially of the disk in accordance with the drive current due to the slider drive signal.

The rotational-speed detecting section 33 detects a frequency signal representative of a current rotation frequency of the spindle motor 22 rotating the hologram record carrier 2 through the turntable, and generates a rotational-speed signal representative of a spindle rotational speed corresponding thereto and supplies it to the rotating-position detecting circuit 34. The rotating-position detecting circuit 34 generates a rotating-position signal and supplies it to the control circuit 37. The control circuit 37 generates a spindle drive signal and supplies it to the spindle servo circuit 35. Thus, the spindle motor 22 is controlled to rotate the hologram record carrier 2.

### ——Optical Pickup——

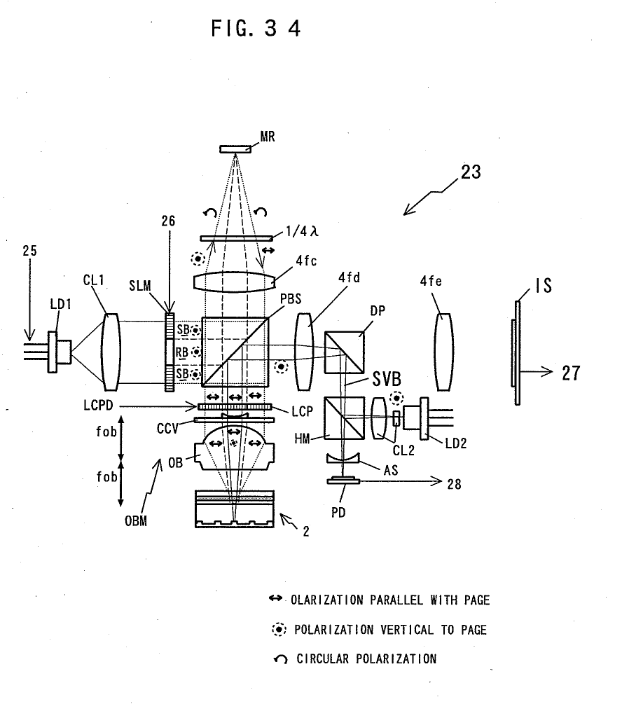

FIG. 34 shows a schematic construction of the pickup 23.

The pickup 23 includes a hologram-recording optical system, a hologram-reproducing optical system and a servo control system. Excepting the objective lens module OBM and its drive system, those systems are arranged within a housing (not shown). There are arranged, on a line, a hologram-recording and reproducing laser light source LD1, a collimator lens CL1, a spatial light modulator SLM, a polarizing beam splitter PBS, a 4f-lens fd, a 4f-lens fe, and an image sensor IS while there are arranged, on a line, a mirror MR, a ¼-wavelength plate ¼λ, a 4f-lens fc, a polarizing beam splitter PBS, a polarizing liquid-crystal panel LCP and an objective lens module OBM. Those components, on those lines, are arranged orthogonal through the polarizing beam splitter PBS.

### ——Hologram-Recording Optical System——

The hologram-recording optical system includes a hologram-recording and reproducing laser light source LD1, a collimator lens CL1, a transmissive spatial light modulator SLM, a polarizing beam splitter PBS, a polarizing liquid-crystal panel LCP, a 4f-lens fc, a mirror MR, a ¼-wavelength plate ¼λ and an objective lens module OBM.

The emission light of the laser light source LD1 is changed into a collimated beam by the collimator lens CL1, which beam enters the spatial light modulator SLM and the polarizing beam splitter PBS in the order. The collimated beam has a polarization in a direction vertical to the paper. The spatial light modulator SLM, for displaying in the central region the page data to record, changes the light flux passing through the central region including the optical axis into a non-modulated reference beam RB, and the annular light flux surrounding it into a signal beam SB. The polarizing beam splitter PBS is arranged to reflect (S polarization) at its polarization film the incident, spatially separated reference and signal beams RB, SB toward the 4f-lens fc. The 4f-lens fc is a lens to form an image on a focal point of the objective lens OB (at the focal length fob on the optical axis). Because of the difficulty in arranging the spatial light modulator SLM at the focal point of the objective lens OB, the distance from the spatial light modulator SLM to the 4f-lens fc is provided as a focal length of the 4f-lens fc. The 4f-lens fc is arranged such that its incident light flux, after transmitted through the ¼-wavelength plate ¼λ and changed into circular polarization, is again reflected by the mirror MR back to the ¼-wavelength plate ¼λ. As a result, the reference and signal beams RB, SB from the ¼-wavelength plate ¼λ have polarization in a direction parallel with the paper, which again enter the polarizing beam splitter PBS. However, those transmit through the polarizing beam splitter PBS because polarized in a horizontal direction with respect to the page (P polarization). The reference and signal beams RB, SB are again focused on the focal point of the 4f-lens fc, which is equivalent to the existence of the spatial light modulator SLM at the focal point. The polarizing liquid-crystal panel LCP is arranged at the focal point and further aligned with the focal point of the objective lens OB of the objective lens module OBM. The polarizing liquid-crystal panel LCP has a molecular orientation of TN type.

As shown in FIG. 35, in the objective lens module OBM, a concave lens optical element CCV is arranged to act only upon the reference beam RB. Setting is made to focus the reference beam RB farther than the focal point, in nature, of the objective lens OB in conjunction with the function of the objective lens OB and to focus the signal beam SB on the focal point of the objective lens OB freely from lens action. The objective lens module OBM is controlled in position relatively to the hologram record carrier 2 such that the signal beam SB is focused by the objective lens OB on a wavelength-selective reflection film 5 of the hologram record carrier 2.

### ——Hologram-Reproducing Optical System——

The hologram-reproducing optical system includes a hologram-recording and reproducing laser light source LD1, a collimator lens CL1, a spatial light modulator SLM, a polarizing beam splitter PBS, a polarizing liquid-crystal panel LCP, an objective lens module OBM, 4f-lenses fc, fd and fe, a mirror MR, a ¼-wavelength plate ¼λ and an image sensor IS, as shown in FIG. 34. In the optical system, the optical components are common to the hologram-recording optical system excepting the 4f-lenses fd and fe and the image sensor IS.

As shown in FIG. 34, the 4f-lens fd of the hologram-reproducing optical system is arranged in a position that its focal point coincides with the focal point of the objective lens OB through the polarizing beam splitter PBS. Furthermore, the 4f-lens fe having a similar focal length to the 4f-lens fd is arranged on the optical axis in a position distant from the 4f-lens fd by two times the focal length thereof. Those constitute so-called a 4f optical system. Because of the difficulty in arranging the image sensor IS in a position of the focal point of the objective lens OB on which a reproduced image is to be focused based on the reproduced light from the hologram record carrier 2, the image sensor IS for receiving reproduced light is arranged such that its light-receiving surface is in a position of the focal point of the 4f-lens fe. A reproduced image is to be formed on the light-receiving surface of the image sensor IS, thereby obtaining a reproduced signal. By reproducing it, the record signal can be reproduced.

### ——Hologram Record Carrier——

The hologram record carrier 2 is structured with a protection layer 8, a hologram record layer 7, a separation layer 6, a wavelength-selective reflection layer 5, a second separation layer 4, a servo guide layer 9 and a substrate 3 on which transferred with address and track structures as shown in FIG. 35, as viewed from the incident side of a reference beam. The wavelength-selective reflection layer 5 is formed of a dielectric layer body that transmits a servo beam SVB but reflects only a reflective wavelength band including the wavelength of the reference and signal beams. On the servo guide layer 9, there are formed servo grooves or pits as servo marks T, such as a plurality of tracks, extending with spacing without crossover. Meanwhile, the servo marks T of the servo guide layer 9 have a pitch Px (so-called a track pitch) set at a predetermined distance as determined from the multiplex degree of holograms HG recorded above the spot of the signal and reference beams. The servo mark T has a width suitably set up in accordance with the output, e.g., push-pull signal, of the photodetector that receives reflection light from the light spot of a servo beam SVB. In accordance with the follow-up of a servo beam SVB over the servo marks T in the servo guide layer 9 of the hologram record carrier 2 shown in FIG. 35, positioning is made on the hologram record carrier 2 in order to implement hologram recording and reproducing (focus servo, xy-directional servo). By focus servo or reproducing a guide-tack signal such as grooves and pits previously recorded, tracking servo and the like can be carried out.

### ——Servo Control System——

The servo control system is to carry out servo control (movement in xyz directions) in the position of the objective lens module OBM relatively to the hologram record carrier 2. It includes a second laser light source LD2 for emitting a servo beam SVB, an adjusting lens CL2, a half mirror MR, a dichroic prism DP, a polarizing beam splitter PBS, an objective lens module OBM, a coupling lens AS and a photo-detector PD, as shown in FIG. 34.

The second laser light source LD2 is for a wavelength (servo beam SVB) different from the wavelength of a recording and reproducing laser. The servo beam SVB is of a wavelength of light that is other than the sensitive wavelength band to signal and reference beams but is not sensitive to the hologram record layer 7.

The servo control system is coupled to the hologram-reproducing optical system through the dichroic prism DP arranged between the 4f-lenses fc and fe of the 4f optical system. Namely, the second laser light source LD2, the adjusting lens CL2, the half mirror MR and the dichroic prism DP are arranged such that the servo beam SVB, from the second laser source LD2, is reflected by the half mirror MR and by the dichroic prism DP and then combined with the light flux of the reproducing optical system. Combined with the detecting-system 4f-lens 4fd, the adjusting lens CL2 is set up such that the servo beam SVB assumes a collimated beam in front of the objective lens module OBM.

As shown in FIG. 35, in the objective lens module OBM, the servo beam SVB has a diameter (da) established equal to or smaller than the diameter (db) of the light flux of the reference beam RB. Accordingly, the outer diameter (dc) and inner diameter (dd) of the signal beam SB and those diameters are in a relationship as dc>dd>db≧da. Here, in case the structure providing a record guide such as record interval (multiple interval) and track pitch, is structurally greater than those of the usual optical disk, the fact that the aberration and light flux diameter of the servo beam SVB decreases and the numerical aperture NA lowers has an insignificant effect upon reading out.

As shown in FIG. 34, because the polarization direction of the servo beam SVB is set up vertical to the paper, the servo beam SVB is allowed to enter the objective lens module OBM without undergoing the effect of the polarizing liquid-crystal panel LCP.

As shown in FIG. 35, the objective lens module OBM is set up together with the hologram record carrier 2 by the combination with the concave lens optical element CCV and objective lens OB such that the servo beam SVB is focused on a point farther than the wavelength-selective reflection layer 5 of the hologram record carrier 2, i.e., transmitting through the wavelength-selective reflection layer 5 into focusing on the servo guide layer 9 where the servo marks T are formed. Here, the concave lens optical element CCV is set up by the combination with the objective lens OB such that the servo beam SVB at its wavelength is focused on the servo guide 9 without causing aberrations.

The servo beam SVB transmits through the wavelength-selective reflection layer 5 and reaches the servo guide layer 9 where it is reflected by the servo guide layer 9.

The reflection light of the servo beam SVB, reflected by the servo guide layer 9 and returning through the objective lens module OBM, reaches the half-mirror MR by way of the same optical path as that of incoming path of from the polarizing beam splitter PBS to the dichroic prism DP, thus entering the photo-detector PD through the servo-signal producing optical system as shown in FIG. 34.

In the photo-detector PD, a focus-servo signal can be obtained by an astigmatism technique, e.g., by a cylindrical lens. Meanwhile, by reading the servo marks T formed on the servo guide layer 9, a tracking-error signal, etc. in a push-pull scheme can be obtained. Besides, an address signal formed by a pit string can be read out.

In this manner, servo control is effected by focusing the servo beam SVB as a light spot on a track on the servo guide layer 9 through the objective lens module OBM, guiding the reflection light to the photodetector PD, and driving the objective lens module OBM by means of an actuator of the objective lens drive section 36 in accordance with the signal detected there.

As shown in FIG. 35, because the wavelength-selective reflection layer 5 is located closer to the objective lens OB (closer to the light illumination) than the servo guide layer 9, the signal and reference beams are to be reflected thus not causing a diffraction light as to the signal and reference beams due to the servo structure (servo marks T) of the servo guide layer 9. This reduces the affection of the diffraction light, thus enabling hologram reproducing with well SN.

### ——Record/Reproduce Operation——

Explanation is made on the record/reproduce operation of the FIG. 34 embodiment.

The emission light from the laser light source LD1 is changed by the collimator lens CL1 into a collimated beam that is to enter the spatial light modulator SLM and the polarizing beam splitter PBS in the order. The collimated beam, divided by the spatial light modulator SLM where, during recording, the page data to record is displayed in the annular region and rendered non-modulated through the central region into reference and signal beams RB, SB, is reflected by the polarizing beam splitter PBS, the ¼-wavelength plate ¼λ and the mirror MR, thus being returned again to and allowed to transmit through the polarizing beam splitter PBS. The transmitted reference and signal beams RB, SB are incident upon the polarizing liquid-crystal panel LCP.

During recording, the central polarizing region PLCCR and the annular polarizing region PLCP of the polarizing liquid-crystal panel LCP shown in FIG. 35 are both put in on-state by applying equal voltage to the transparent electrodes thereof. Accordingly, no polarizing action occurs at the polarizing liquid-crystal panel LCP so that the transmitting signal and reference beams SB, RB do not undergo polarization effect and hence the polarization directions (parallel with the paper) thereof are unchanged.

The signal and reference beams SB, RB, transmitted through the polarizing liquid-crystal panel LCP, enter the objective lens module OBM with the polarization directions thereof maintained unchanged. The signal beam SB is focused on the focal point in nature of the objective lens OB because no undergoing the effect of the concave lens optical element CCV whereas the reference beam RB is focused on a point farther than the focal point because undergoing a concave-lens effect.

Because the wavelength-selective reflection layer 5 of the hologram record carrier 2 is set up to reflect the rays having a wavelength of the recording and reproducing laser, the signal beam SB is focused on and reflected by the wavelength-selective reflection layer 5. Meanwhile, the reference beam RB in a defocus state is reflected by the wavelength-selective reflection layer 5. An overlap region occurs at the signal beam SB and the incident reference beam RB, where interference occurs between the reference beam RB and the signal beam SB. By arranging the hologram record layer 7 in this region (in the region where is closer to the objective lens than the focal point as to the signal beam SB and overlap is occurring between the incident reference beam RB and the signal beam SB), a hologram is recorded in the hologram record layer 7.

During reproducing, as shown in FIG. 36, the emission light of the laser light source LD1 is blocked by the annular region of the spatial light modulator SLM, to pass its light flux including the optical axis without modulation through the central region, thereby producing a reference beam RB. The reference beam RB is caused to reach the central polarizing region PLCCR of the polarizing liquid-crystal panel LCP by way of the similar path to that of recording. Here, the polarizing liquid-crystal panel LCP is placed in off-state (voltage not applied) at the annular polarizing region PLCPR and maintained in on-state at the central polarizing region PLCC. Because the reference beam RB enters the hologram record layer 7 with the polarization maintained in a direction parallel with the paper, the reproduced light is of a light flux diverging and converging similarly to the signal beam upon recording and polarized in a direction parallel with the paper. Accordingly, the reproduced light undergoes a polarization effect because of transmission through the annular polarizing region PLCPR of the polarizing liquid-crystal panel LCP, to have a polarization in a direction vertical to the paper. Meanwhile, the reference beam RB remaining parallel with the paper is reflected by the wavelength-selective reflection layer 5 wherein no polarization effect is not undergone through the liquid crystal, thus being different in polarization direction from the reproduced light. Accordingly, the reproduced light is vertical to the paper and hence reflected by the polarizing beam splitter PBS whereas the signal beam SB is allowed to transmit through it. The reproduced light thus separated is focused on the light-receiving surface of the image sensor IS through the 4f-lenses fd and fe of the detection system. Thus, a reproduced image is obtained and the image sensor IS outputs the reproduced signal.

As described so far, because of the difference in polarizing direction between the reference beam RB reflected by the wavelength-selective reflection layer 5 and the reproduced light during reproducing, separation is available with the polarizing beam splitter PBS or the like. Reproduction SN improves because the reference beam RB is not incident upon the detector that detects reproduced light.

In this manner, the reference beam for hologram recording is of a collimated light flux in the prior art, the present embodiment diverges or converges signal and reference beams such that the focal points thereof are provided different by means of a particular objective lens module. In addition, by using a particular polarization-plane rotating device such as a polarizing liquid-crystal panel, polarization state is structurally switched over between recording and reproducing. Meanwhile, the objective lens module is set up such that the particular optical element combined with the objective lens is allowed to focus the servo beam using a wavelength different from the wavelength of recording and reproducing laser on the servo guide layer of the hologram record carrier without aberrations.

Furthermore, although the prior art requires to change the optical system for recording and reproducing, the present embodiment can obtain the same effect by controlling the application voltage to the polarizing liquid-crystal panel.

Meanwhile, in the prior art, shift multiplex recording is impossible and record capacity is less because the reference beam is of collimated light. However, in the present embodiment, a quality reproduced signal can be obtained with the reference beam RB made in converged light thus enabling shift multiplex. This is effective particularly for such a case where, after recording, there encounters a difference in reference-beam wave front upon between recording and reproducing due to a contraction or refractive index change in the hologram record layer. Meanwhile, because aberrations are removed at the wavelength of the servo beam SVB by the combination of the optical element and the objective lens, the servo signal can be reproduced well.

Furthermore, space saving can be realized by arranging the combining optical path with the servo beam within the 4f-system of the detection system. Because a combining prism for combining optical paths can be arranged in the focus optical system, the prism and the like can be reduced in effective diameter.

### ——Modification of Servo Control System——

The foregoing embodiment was explained on the usage of the hologram record carrier comprising a wavelength-selective reflection layer and a servo guide layer which is placed at a position farther than the wavelength-selective reflection layer from the objective lens optical system (i.e., the focus of the servo beam SVB is farther than that of the signal beam). In addition to that embodiment, there is another modification in which, as shown in FIG. 37, the servo control system can use a hologram record carrier comprising a hologram record layer 7 and a servo guide layer 90 which is placed at a position nearer to the objective lens module OBM of the objective lens optical system than the hologram record layer 7. In this case, the servo guide layer 90 is formed of a material having a wavelength-selective nature such as a dielectric layer body that transmits the reference beam RB and the signal beam SB but reflects a servo beam SVB. Thus, the hologram record carrier 2 is structured with a protection layer 8, a wavelength-selective servo guide layer 90, a second separation layer 4, a hologram record layer 7, a separation layer 6, a reflection layer 5 and a flat substrate 3, as viewed from the incident side of a reference beam.

In case that the servo beam SVB is focused farther than that of the signal beam in this modification, in order to separate the servo beam from a reproduced light, the wavelength of the servo beam SVB is set to be different from those of the reference beam RB and the signal beam SB. The diameter of the servo beam SVB (da) is set to equal to or smaller than the diameter (db) of the light flux of the reference beam. Therefore, the outer diameter (dc) and inner diameter (dd) of the signal beam SB and those diameters are in a relationship as dc>dd>db≧da.

The wavelength-selective servo guide layer 90 is formed on the near side of the objective lens OB before the hologram record layer 7. Since the wavelength-selective servo guide layer 90 selectively reflects the servo beam SVB and transmits the reference beam RB and the signal beam SB, the recording and reproducing of data are practicable. The operations of the recording and reproducing of data of this modification are the same as those of the foregoing servo control system.

The objective lens module OBM used in this modification is the same as that shown in FIG. 7. Therefore, since the polarization of the servo beam SVB is set to be in a direction vertical to the paper, as shown in FIG. 37, the servo beam SVB is incident to the convex lens reflection layer CVX without influence of the action of the polarizing liquid-crystal panel LCP and then is focused on the wavelength-selective servo guide layer 90 before the hologram record layer 7 due to a combination of the convex lens reflection layer CVX and the objective lens OB. The servo beam SVB passes through the wavelength-selective reflection layer 5 and is focused to the servo guide layer 9 which is placed far from the objective lens OB and has servo marks T such as tracks. As a result, by reading-out the servo marks T, a servo signal such as a tracking-error signal, etc. in a push-pull scheme can be obtained.

### ——Another Modification of Servo Control System——

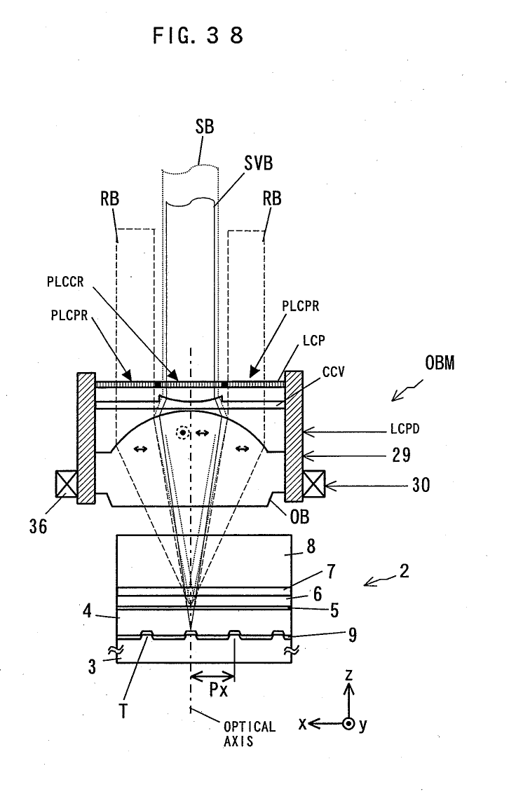

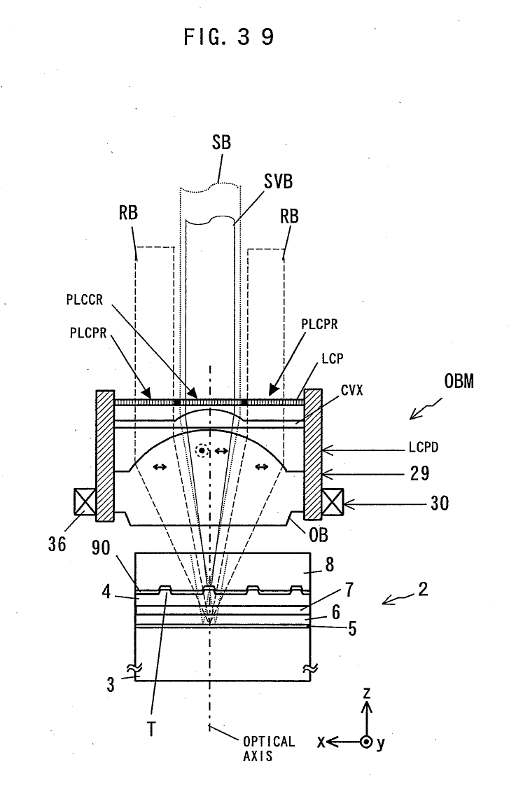

The foregoing embodiments were explained in the main on the arrangement that the reference beam is placed on the optical axis and the signal beam surrounds it in the combination of the polarizing liquid-crystal panel LCP and the spatial light modulator SLM. On the contrary, as another embodiment, it is possible that the signal beam SB is placed on the optical axis and the reference beam RB surrounds it as shown in FIG. 38. In this case, as shown in FIG. 30, the spatial light modulator SLM can be wholly structured as a transmission matrix liquid-crystal display device to display, by means of the control circuit 26, a central region LCCR for displaying a predetermined pattern of page data to record and the surrounding annular region LCPR, surrounding it, for displaying a non-modulated light-transmissive region. Further, in the polarizing liquid-crystal panel LCP, the polarization liquid-crystal drive circuit LCPD provides the both regions with the same polarization of light-transmission state during hologram recording, and as shown in FIG. 31, during reproducing, it provides different polarizing states to the central polarizing region PLCCR (off-state) and the annular polarizing region PLCPR (on-state) of the polarizing liquid-crystal panel LCP. The operations of the recording and reproducing of data of this modification are the same as those of the foregoing servo control system.

In addition to the arrangement that the signal beam SB is placed on the optical axis and the reference beam RB surrounds it, as shown in FIG. 39, it is possible to use a hologram record carrier comprising a wavelength-selective servo guide layer 90 placed at a position being nearer to the objective lens module OBM than the hologram record layer 7, i.e., the focus of the servo beam SVB is before that of the signal beam. The operations of the recording and reproducing of data of this modification are the same as those of the foregoing servo control system.

### ——Other Pickup Modifications——

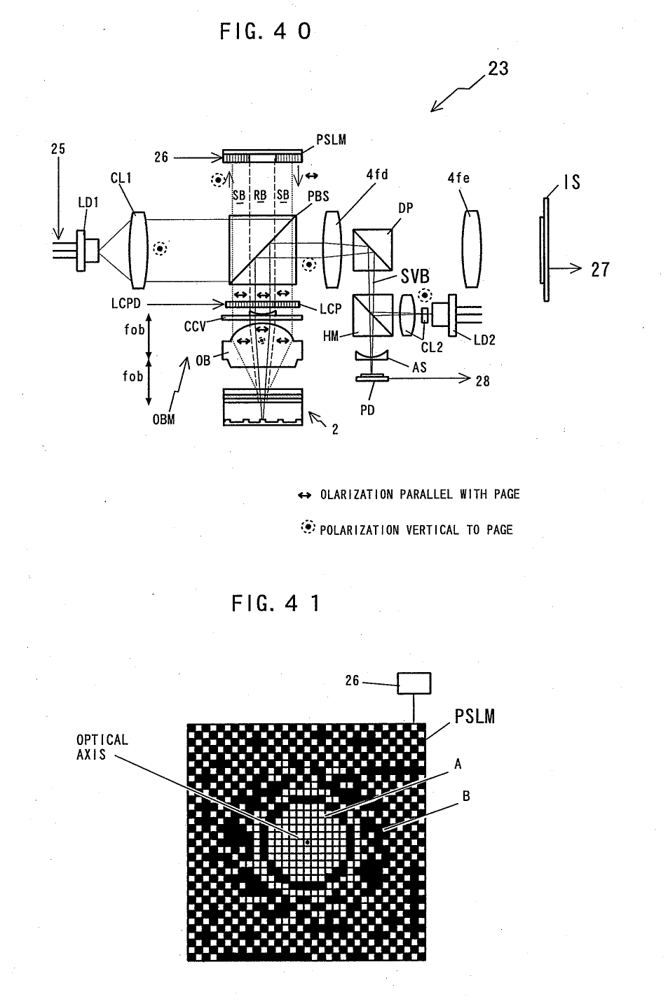

FIG. 40 shows a structure of another pickup.

The pickup is similar to the pickup 23 excepting in removing the pickup shown in FIG. 34 of the mirror MR, the ¼-wavelength plate ¼λ and the 4f-lens fc and arranging, on the optical axis of those, a reflective polarizing spatial light modulator PSLM in place of the transmission spatial light modulator SLM so that the light flux, from the hologram-recording and reproducing laser light source LD1, is caused to enter the polarizing spatial light modulator PSLM through the polarizing beam splitter PBS thereby using the reflection light thereof. Accordingly, record/reproduce operation is to be implemented similarly to the pickup 23.

The polarizing spatial light modulator PSLM is so-called a LCOS (liquid crystal on silicon) device with a division as a central region A closer to and including the optical axis and a spatial light modulating region B surrounding it and not including the optical axis, as shown in FIG. 41. The reflecting light flux is modulated with a 90-degree-rotating polarization. At the time that the polarizing spatial light modulator PSLM reflects a light flux, the light flux is separated, on the same axis, as a signal beam SB spatially modulated through the spatial light modulating region B and a reference beam RB not spatially modulated through the central region A.

The polarizing spatial light modulator PSLM has a function to electrically polarize a part of incident light on a pixel-by-pixel basis by means of a liquid-crystal panel having a plurality of pixel electrodes divided in a matrix form. The polarizing spatial light modulator PSLM is connected to the spatial-light-modulator drive circuit 26 so that a signal beam SB annular in section can be produced by modulating the light-flux polarization in a manner providing a distribution based on the recording page data given therefrom.

Meanwhile, the polarizing spatial light modulator PS can maintain the same polarization upon incidence and reflection. Therefore, in case control is made into a reflection state while maintaining the modulation state only through the spatial light modulating region B, the combination with the polarizing beam splitter PBS provides the function as a shutter, thus supplying the objective lens module OBM with only the reference beam not spatially modulated through the central region A.

1. A hologram recording and reproducing system for recording or reproducing information to or from a hologram record carrier that stores an optical interference pattern of a reference beam and a signal beam therein as a diffraction grating, the hologram recording and reproducing system comprising:
light producing means that generates a reference beam and a signal beam based on a coherent beam in which the coherent beam is modulated into the signal beam according to information to be recorded;
interference means that allows one of the reference and signal beams to propagate axially on an optical axis as a central region light flux and allows the other of the reference and signal beams to propagate coaxially and annularly in section as an annular region light flux surrounding the one spatially separated from the other in a same direction and converges both the reference beam and the signal beam on different focal points in the optical axis respectively through an objective lens optical system to cause interference between the reference beam and the signal beam;
a hologram record carrier having a hologram record layer located on a side of a near one of the different focal points to the objective lens optical system and a reflection layer located on a side of a distant one of the different focal points from the objective lens optical system; and
image detecting means arranged on the optical axis and for receiving a beam returning from the hologram record layer through the objective lens optical system when the reference beam is illuminated to the hologram record layer;
wherein the hologram record carrier further comprising a servo guide layer which is placed at a position either nearer to the objective lens optical system than the hologram record layer or farther than the reflection layer from the objective lens optical system,
the hologram recording and reproducing system further comprising a servo control system for focusing a servo beam onto the servo guide layer and for receiving a reflection light returning from the servo guide layer to photoelectrically convert it to a signal and for driving the objective lens optical system in accordance with the signal photoelectrically converted, wherein the servo beam has a wavelength different from the coherent beam wavelength and passes through the central region coaxially with the central region light flux including the optical axis.

2. The hologram recording and reproducing system according to claim 1, wherein the servo guide layer, which is placed at a position nearer to the objective lens optical system than the hologram record layer, is formed of a material having a wavelength-selective nature that transmits the coherent beams but reflects the servo beam.

3. The hologram recording and reproducing system according to claim 1, wherein the reflection layer, which is placed at a position nearer to the objective lens optical system than the servo guide layer, is formed of a material having a wavelength-selective nature that transmits the coherent beams but reflects the servo beam.

4. The hologram recording and reproducing system according to claim 1, wherein the hologram record carrier further comprises a separation layer between the hologram record layer and the reflection layer.

5. The hologram recording and reproducing system according to claim 1, wherein the hologram record carrier further comprises a second separation layer either between the hologram record layer and the servo guide layer or between the reflection layer and the servo guide layer.

6. The hologram recording and reproducing system according to claim 1, further comprising a polarization-plane rotating device having a central polarizing region arranged on the optical axis and an annular polarizing region arranged in a manner surrounding the central polarizing region and for making transmission components through the central and annular polarizing regions different in rotation angle on the polarization plane from each other.

7. The hologram recording and reproducing system according to claim 1, wherein the spatial light modulator is structured by a transmission matrix liquid-crystal display device, the central region being formed by a through-opening or of a transparent material.

8. The hologram recording and reproducing system according to claim 1, wherein the spatial light modulator is structured by a transmission matrix liquid-crystal display device, the central region being also structured by a transmission matrix liquid-crystal display device, whereby the central region is in a light transmission state during recording.

9. The hologram recording and reproducing system according to claim 7, wherein the polarization-plane rotating device is structured by a transmission liquid-crystal device, the central polarizing region being formed by a through-opening or of a transparent material.

10. The hologram recording and reproducing system according to claim 7, wherein the polarization-plane rotating device is structured by a transmission liquid-crystal device, the central polarizing region being also formed by a transmission liquid-crystal device, whereby the central polarizing region is in a light transmission state not to cause modulation during recording or reproducing.

11. The hologram recording and reproducing system according to claim 1, wherein the spatial light modulator is structured by a transmission matrix liquid-crystal display device, the annular region being formed by a through-opening or of a transparent material.

12. The hologram recording and reproducing system according to claim 1, wherein the spatial light modulator is structured by a transmission matrix liquid-crystal display device, the annular region being also structured by a transmission matrix liquid-crystal display device, whereby the annular region is in a light transmission state during recording.

13. The hologram recording and reproducing system according to claim 11, wherein the polarization-plane rotating device is structured by a transmission liquid-crystal device, the annular polarizing region being formed by a through-opening or of a transparent material.

14. The hologram recording and reproducing system according to claim 11, wherein the polarization-plane rotating device is structured by a transmission liquid-crystal device, the annular polarizing region being also formed by a transmission liquid-crystal device, whereby the annular polarizing region is in a light transmission state not to cause modulation during recording or reproducing.

15. The hologram recording and reproducing system according to claim 1, wherein the objective lens optical system is a bifocal lens having a convex or concave lens or a Fresnel lens surface or diffraction grating having a convex or concave lens action formed integral with the focus lens and formed coaxially in a refractive surface thereof.

16. The hologram recording and reproducing system according to claim 1, wherein the objective lens optical system is a focus lens and a transmission optical element having a convex or concave lens or a Fresnel lens surface or diffraction grating having a convex or concave lens action formed coaxially with the focus lens.

17. The hologram recording and reproducing system according to claim 6, wherein the servo beam is set so as to enter with a polarization state which is different 90 degrees in the polarization state from that of the light flux including the optical axis and passing through the central polarizing region of the polarization-plane rotating device.
